(19) United States
(12) Patent Application Publication
(10) Pub. No.: US 2011/0191005 A1
(43) Pub. Date: Aug. 4, 2011

(54) APPARATUS FOR DETECTING ABNORMAL AIR-FUEL RATIO VARIATION AMONG CYLINDERS OF MULTI-CYLINDER INTERNAL COMBUSTION ENGINE

(75) Inventors: Yasushi Iwazaki, Ebina-shi (JP); Mie Sasai, Susono-shi (JP); Hiroshi Sawada, Gotenba-shi (JP); Hiroshi Miyamoto, Susono-shi (JP); Keiji Imamura, Susono-shi (JP)

(73) Assignee: Toyota Jidosha Kabushiki Kaisha, Toyota-shi (JP)

(21) Appl. No.: 13/020,878

(22) Filed: Feb. 4, 2011

(30) Foreign Application Priority Data
Feb. 4, 2010 (JP) JP2010-023398
Oct. 7, 2010 (JP) JP2010-227454

(51) Int. Cl. G01M 15/00; F01N 11/00

(52) U.S. Cl. 701/101

(57) ABSTRACT

An apparatus for detecting an abnormal air-fuel ratio variation among cylinders of a multi-cylinder internal combustion engine includes: a catalyst that is arranged in an exhaust passage of the multi-cylinder internal combustion engine; a catalyst temperature detecting unit that detects a temperature of the catalyst; and an abnormality detecting unit that detects an abnormal air-fuel ratio variation among the cylinders on the basis of the detected catalyst temperature, wherein the abnormality detecting unit calculates a temperature parameter on the basis of the detected catalyst temperature, and the abnormality detecting unit detects the abnormal air-fuel ratio variation among the cylinders on the basis of the temperature parameter at the time when a predetermined period of time has elapsed after a cold start of the internal combustion engine.

### CROSS-REFERENCE TO RELATED APPLICATIONS

This application claims priority to Japanese Patent Application No. 2010-023398 filed on Feb. 4, 2010, and claims priority to Japanese Patent Application No. 2010-227454 filed on Oct. 7, 2010, both of which are incorporated herein by reference in their entirety including the specification, drawings and abstract.

### BACKGROUND OF THE INVENTION

1. Field of the Invention

The invention relates to an apparatus for detecting an abnormal air-fuel ratio variation among cylinders of a multi-cylinder internal combustion engine and, more particularly, to an apparatus for detecting a relatively large air-fuel ratio variation among cylinders with respect to a predetermined value in a multi-cylinder internal combustion engine.

2. Description of the Related Art

Generally, in an internal combustion engine provided with an exhaust gas control system that uses a catalyst, it is necessary to control the mixture ratio of an air-fuel mixture burned in the internal combustion engine, that is, the air-fuel ratio, in order to purify toxic substances in exhaust gas using the catalyst with high efficiency. To control the air-fuel ratio, an air-fuel ratio sensor is provided in an exhaust passage of the internal combustion engine, and then feedback control is executed so that the air-fuel ratio detected by the air-fuel ratio sensor coincides with a predetermined target air-fuel ratio.

On the other hand, in a multi-cylinder internal combustion engine, air-fuel ratio control is usually executed over all the cylinders using the same control amount, so an actual air-fuel ratio may vary among the cylinders even when air-fuel ratio control is executed. At this time, if the variation is small, the variation may be absorbed by air-fuel ratio feedback control, and, in addition, toxic substances in exhaust gas may be purified by the catalyst. Therefore, such small variation does not influence exhaust emissions.

However, for example, if a fuel injection system of part of the cylinders fails and, therefore, the air-fuel ratio varies by a large amount among the cylinders as compared with that during normal times, exhaust emissions deteriorate. It is desirable that such a large air-fuel ratio variation that deteriorates exhaust emissions is detected as an abnormal variation. Particularly, in the case of an internal combustion engine for an automobile, it is required to detect an abnormal air-fuel ratio variation among the cylinders in an on-board state in order to prevent travel of a vehicle that emits deteriorated exhaust emissions.

For example, an apparatus described in Japanese Patent Application Publication No. 2009-257236 (JP-A-2009-257236) detects an abnormal air-fuel ratio variation among cylinders using a correlation between a degree of air-fuel ratio variation among the cylinders and a catalyst temperature.

### SUMMARY OF INVENTION

The invention provides an apparatus for detecting an abnormal air-fuel ratio variation among cylinders of a multi-cylinder internal combustion engine, which is able to detect an abnormal air-fuel ratio variation among the cylinders using a catalyst temperature with further high accuracy.

A first aspect of the invention provides an apparatus for detecting an abnormal air-fuel ratio variation among cylinders of a multi-cylinder internal combustion engine. The apparatus includes: a catalyst that is arranged in an exhaust passage of the multi-cylinder internal combustion engine; a catalyst temperature detecting unit that detects a temperature of the catalyst; and an abnormality detecting unit that detects an abnormal air-fuel ratio variation among the cylinders on the basis of the detected catalyst temperature, wherein the abnormality detecting unit calculates a temperature parameter on the basis of the detected catalyst temperature, and the abnormality detecting unit detects the abnormal air-fuel ratio variation among the cylinders on the basis of the temperature parameter at the time when a predetermined period of time has elapsed after a cold start of the internal combustion engine.

At the time of a cold start of the internal combustion engine, the catalyst temperature is stable around an ambient temperature. Therefore, an abnormal air-fuel ratio variation among the cylinders is detected on the basis of the temperature parameter at the time when a predetermined period of time has elapsed after a cold start of the internal combustion engine. By so doing, an initial condition of the catalyst temperature, that is, the temperature parameter, may be made uniform for each detection, so it is possible to further improve detection accuracy.

A second aspect of the invention provides an apparatus for detecting an abnormal air-fuel ratio variation among cylinders of a multi-cylinder internal combustion engine. The apparatus includes: a catalyst that is arranged in an exhaust passage of the multi-cylinder internal combustion engine; a catalyst temperature detecting unit that detects a temperature of the catalyst; and an abnormality detecting unit that detects an abnormal air-fuel ratio variation among the cylinders on the basis of the detected catalyst temperature, wherein the abnormality detecting unit detects the abnormal air-fuel ratio variation among the cylinders on the basis of the detected catalyst temperature at the time when a predetermined period of time has elapsed after a cold start of the internal combustion engine.

According to the aspects of the invention, an excellent advantageous effect that an abnormal air-fuel ratio variation among the cylinders may be detected using a catalyst temperature with further high accuracy is obtained.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a schematic view of an internal combustion engine according to an embodiment of the invention;

FIG. 2 is a graph that shows the output characteristics of a pre-catalyst sensor and a post-catalyst sensor according to the embodiment of the invention;

FIG. 3 is a graph that shows fluctuations in exhaust gas air-fuel ratio in accordance with a degree of air-fuel ratio variation among cylinders according to the embodiment of the invention;

FIG. 4 is a graph that shows the relationship between an imbalance percentage and a catalyst temperature according to the embodiment of the invention;

FIG. 5 is a time chart that shows changes in catalyst temperature after a cold start of the internal combustion engine according to the embodiment of the invention;

FIG. 6 is a time chart similar to that of FIG. 5 for illustrating correction in accordance with a degree of degradation of a catalyst according to the embodiment of the invention;

FIG. 7 is a time chart for illustrating a method of measuring an oxygen storage capacity according to the embodiment of the invention;

FIG. 8 is a time chart similar to that of FIG. 5 for illustrating correction in accordance with an average air-fuel ratio according to the embodiment of the invention;

FIG. 9 is a flowchart that shows the routine for detecting an abnormal air-fuel ratio variation among the cylinders according to the embodiment of the invention;

FIG. 10 is a map that defines the relationship between an oxygen storage capacity and a correction coefficient in advance according to the embodiment of the invention;

FIG. 11 is a map that defines the relationship between an average air-fuel ratio and a correction coefficient in advance according to the embodiment of the invention;

FIG. 12A to FIG. 12F are graphs for illustrating the principles of identifying an abnormal cylinder according to the embodiment of the invention; and

FIG. 13A and FIG. 13B is a flowchart that shows the routine for identifying an abnormal cylinder according to the embodiment of the invention.

FIG. 14 is a time chart that shows changes in vehicle speed, coolant temperature and catalyst temperature when an FFV is caused to travel after a cold start of an internal combustion engine according to an embodiment of the invention;

FIG. 15 is a time chart similar to FIG. 5 for illustrating correction in accordance with an alcohol concentration according to the embodiment of the invention;

FIG. 16 is a schematic view of the internal combustion engine suitable for correcting an alcohol concentration according to the embodiment of the invention;

FIG. 17 is a flowchart that shows the routine of detecting an abnormal air-fuel ratio variation among the cylinders involving correction of an alcohol concentration according to the embodiment of the invention;

FIG. 18 is a map that defines the relationship between an alcohol concentration and a correction coefficient according to the embodiment of the invention;

FIG. 19 is a flowchart that shows the routine of estimating a catalyst temperature according to the embodiment of the invention;

FIG. 20 is a flowchart that shows the routine of detecting an abnormal air-fuel ratio variation among the cylinders after completion of engine warm-up according to the embodiment of the invention; and

FIG. 21 is a map that defines the relationship between an alcohol concentration and a correction coefficient according to the embodiment of the invention.

### DETAILED DESCRIPTION OF EMBODIMENTS

Hereinafter, an embodiment of the invention will be described with reference to the accompanying drawings.

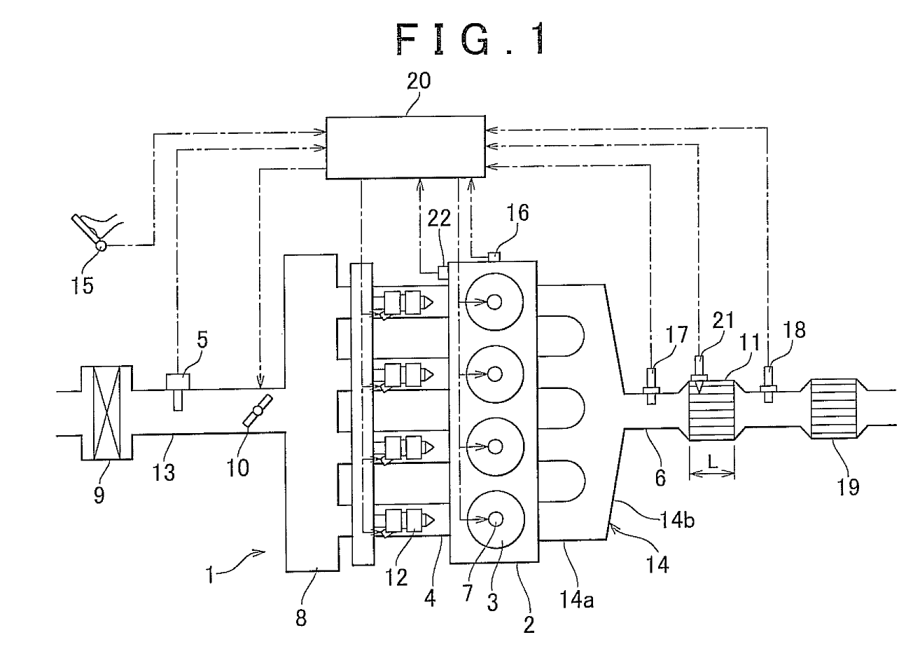

FIG. 1 is a schematic view of an internal combustion engine according to the present embodiment. As shown in the drawing, the internal combustion engine (engine) 1 burns a mixture of fuel and air in combustion chambers 3 formed in a cylinder block 2 to reciprocally move pistons in the respective combustion chambers 3, thus generating power. The internal combustion engine 1 according to the present embodiment is a multi-cylinder internal combustion engine mounted on an automobile and, more specifically, a parallel four cylinder spark ignition internal combustion engine, that is, a gasoline engine. However, the internal combustion engine to which the aspect of the invention may be applied is not limited to such an internal combustion engine, and the number of cylinders, type, and the like, are not specifically limited as long as the internal combustion engine is a multi-cylinder internal combustion engine.

Although not shown in the drawing, an intake valve that opens or closes an intake port and an exhaust valve that opens or closes an exhaust port are arranged on a cylinder head of the internal combustion engine 1 in correspondence with each of the cylinders, and the intake valves and the exhaust valves are respectively opened or closed by camshafts. An ignition plug 7 for igniting an air-fuel mixture in the combustion chamber 3 is attached to the top of the cylinder head in correspondence with each cylinder.

The intake ports of the respective cylinders are connected to a surge tank 8 via branch pipes 4 of the cylinders. The surge tank 8 is an intake manifold chamber. An intake pipe 13 is connected to the upstream side of the surge tank 8, and an air cleaner 9 is provided at an upstream end of the intake pipe 13. Then, an air flow meter 5 for detecting an intake air amount and an electronically controlled throttle valve 10 are assembled to the intake pipe 13 in order from the upstream side. An intake passage is formed of the intake ports, the branch pipes, the surge tank 8 and the intake pipe 13.

An injector (fuel injection valve) 12 that injects fuel into the intake passage, particularly, the intake port, is arranged in correspondence with each cylinder. Fuel injected from the injector 12 is mixed with intake air to become an air-fuel mixture. The air-fuel mixture is taken into the combustion chamber 3 when the intake valve is open, compressed by the piston and then ignited and burned by the ignition plug 7.

On the other hand, the exhaust ports of the respective cylinders are connected to an exhaust manifold 14. The exhaust manifold 14 is formed of branch pipes 14a and an exhaust manifold portion 14b. The branch pipes 14a form the upstream portion of the exhaust manifold 14 in correspondence with each cylinder. The exhaust manifold portion 14b forms the downstream portion of the exhaust manifold 14. An exhaust pipe 6 is connected to the downstream side of the exhaust manifold portion 14b. An exhaust passage is formed of the exhaust ports, the exhaust manifold 14 and the exhaust pipe 6.

Three-way catalysts, that is, an upstream catalyst 11 and a downstream catalyst 19, are serially assembled respectively to the upstream side and downstream side of the exhaust pipe 6. First and second air-fuel ratio sensors, that is, a pre-catalyst sensor 17 and a post-catalyst sensor 18, are respectively provided at the upstream side and downstream side of the upstream catalyst 11 in order to detect the air-fuel ratio of exhaust gas. These pre-catalyst sensor 17 and post-catalyst sensor 18 are provided in the exhaust passage at positions immediately before and after the upstream catalyst 11, and detect the air-fuel ratio on the basis of the oxygen concentration in exhaust gas. In this way, the single pre-catalyst sensor 17 is provided at an exhaust gas collecting portion upstream of the upstream catalyst 11. The upstream catalyst 11 corresponds to a “catalyst” according to the aspect of the invention.

The above described ignition plugs 7, throttle valve 10, injectors 12, and the like, are electrically connected to an electronic control unit (hereinafter referred to as ECU) 20 as a control unit. The ECU 20 includes a CPU, a ROM, a RAM, an input/output port, a storage device, and the like (all of which are not shown). In addition, as shown in the drawing, in addition to the above described air flow meter 5, pre-catalyst sensor 17 and post-catalyst sensor 18, a crank angle sensor 16, an accelerator operation amount sensor 15, a temperature sensor 21, a coolant temperature sensor 22 and other various sensors (not shown) are electrically connected to the ECU 20 via an A/D converter (not shown), or the like. The crank angle sensor 16 detects the crank angle of the internal combustion engine 1. The accelerator operation amount sensor 15 detects the accelerator operation amount. The temperature sensor 21 detects the temperature (bed temperature) of the upstream catalyst 11. The coolant temperature sensor 22 detects the temperature of coolant of the internal combustion engine 1. The ECU 20 controls the ignition plugs 7, the throttle valve 10, the injectors 12, and the like, on the basis of values detected by various sensors, or the like, so as to obtain desired output to thereby control the ignition timing, the fuel injection amount, the fuel injection timing, the throttle opening degree, and the like. Note that the throttle opening degree is normally controlled to an opening degree corresponding to an accelerator operation amount.

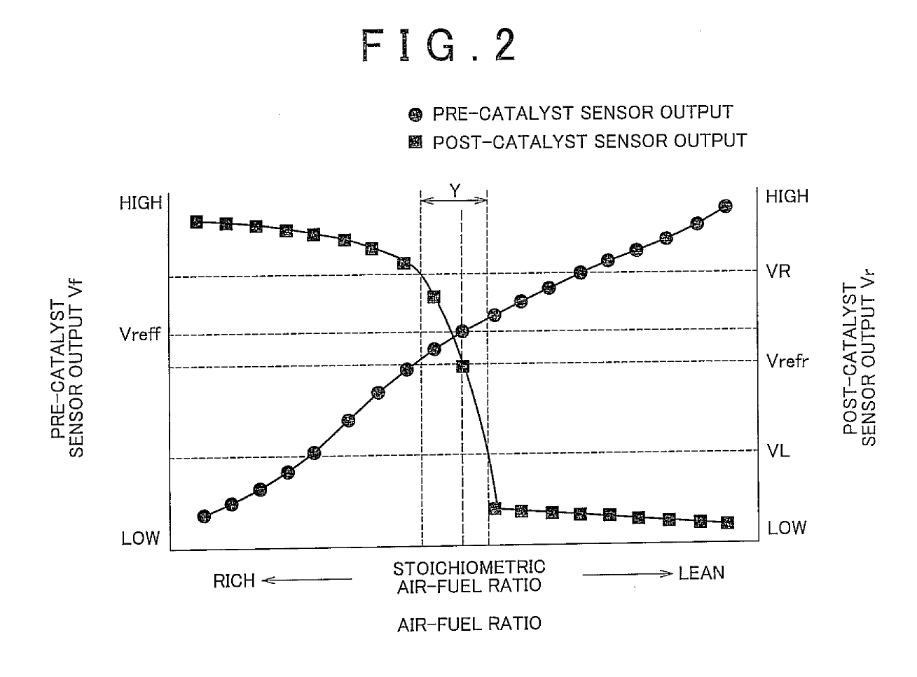

The pre-catalyst sensor 17 is formed of a so-called wide range air-fuel ratio sensor and is able to continuously detect the air-fuel ratio over a relatively wide range. FIG. 2 shows the output characteristics of the pre-catalyst sensor 17. As shown in the graph, the pre-catalyst sensor 17 outputs a voltage signal Vf having a level that is proportional to a detected exhaust gas air-fuel ratio (pre-catalyst air-fuel ratio A/Ff). When the exhaust gas air-fuel ratio is a stoichiometric air-fuel ratio (for example, A/F=14.5), the output voltage is Vreff (for example, about 3.3 V).

On the other hand, the post-catalyst sensor 18 is formed of a so-called O₂ sensor, and has such a characteristic that the output value steeply varies at the stoichiometric air-fuel ratio. FIG. 2 shows the output characteristics of the post-catalyst sensor 18. As shown in the drawing, when the exhaust gas air-fuel ratio (post-catalyst air-fuel ratio A/Fr) is a stoichiometric air-fuel ratio, the output voltage, that is, a stoichiometric air-fuel ratio corresponding value, is Vrefr (for example, 0.45 V). When the exhaust gas air-fuel ratio is leaner than the stoichiometric air-fuel ratio, the output voltage of the post-catalyst sensor is lower than the stoichiometric air-fuel ratio corresponding value Vrefr; whereas, when the exhaust gas air-fuel ratio is richer than the stoichiometric air-fuel ratio, the output voltage of the post-catalyst sensor is higher than the stoichiometric air-fuel ratio corresponding value Vrefr.

The upstream catalyst 11 and the downstream catalyst 19 each purify NOx, HC and CO, which are toxic substances in exhaust gas, at the same time when the air-fuel ratio A/F of exhaust gas flowing into the catalyst is near the stoichiometric air-fuel ratio. The range (window) of air-fuel ratio, in which these three substances may be purified at the same time with high efficiency, is narrow.

Air-fuel ratio control is executed by the ECU 20 so that the air-fuel ratio of exhaust gas flowing into the upstream catalyst 11 is controlled to near the stoichiometric air-fuel ratio. The air-fuel ratio control is formed of main air-fuel ratio control (main air-fuel ratio feedback control) and auxiliary air-fuel ratio control (auxiliary air-fuel ratio feedback control). In the main air-fuel ratio control, the exhaust gas air-fuel ratio detected by the pre-catalyst sensor 17 is brought to coincide with the stoichiometric air-fuel ratio that is a predetermined target air-fuel ratio. In the auxiliary air-fuel ratio control, the exhaust gas air-fuel ratio detected by the post-catalyst sensor 18 is brought to coincide with the stoichiometric air-fuel ratio.

Referring back to FIG. 1, the temperature sensor 21 directly detects the catalyst bed temperature in such a manner that the temperature detecting portion (element portion) is inserted in the upstream catalyst 11. The location of the temperature detecting portion may be basically selected. In the present embodiment, because of the following reason, the location of the temperature detecting portion is located upstream (forward) of a middle position L/2 of a flow passage length L of the upstream catalyst 11.

Then, for example, it is assumed that part of the injectors 12 of all the cylinders fail and an air-fuel ratio variation (imbalance) occurs among the cylinders. For example, this is the case where the fuel injection amount of the cylinder #1 is higher than those of the other cylinders #2, #3 and #4, and the air-fuel ratio of the cylinder #1 deviates toward a rich side by a large amount. In this case as well, when a relatively large correction amount as compared with that during normal times is applied through the above described main air-fuel ratio feedback control, the air-fuel ratio of total gas supplied to the pre-catalyst sensor 17 may be controlled to the stoichiometric air-fuel ratio. However, observing the air-fuel ratio cylinder by cylinder, the air-fuel ratio of the cylinder #1 is much richer than the stoichiometric air-fuel ratio, the air-fuel ratio of each of the cylinders #2, #3 and #4 is leaner than the stoichiometric air-fuel ratio, and then the air-fuel ratio of all the cylinders is the stoichiometric air-fuel ratio in total, so it is apparently undesirable in terms of emissions. Then, in the present embodiment, an apparatus for detecting the abnormal air-fuel ratio variation among the cylinders is provided.

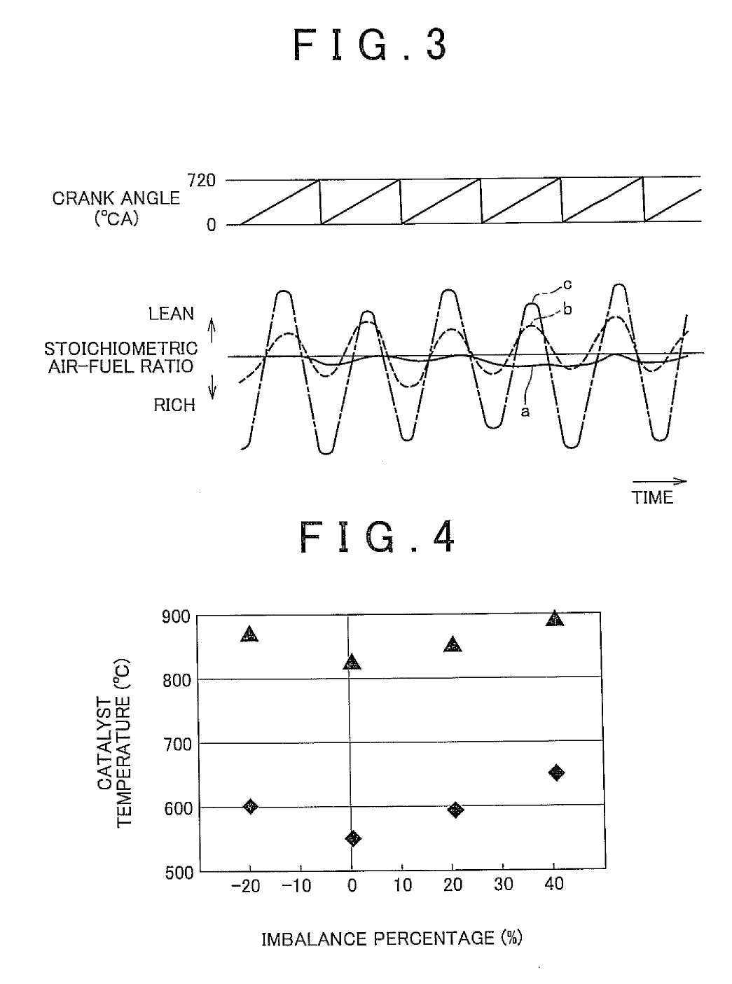

As shown in FIG. 3, as the air-fuel ratio variation occurs among the cylinders, fluctuations in exhaust gas air-fuel ratio increase during one engine cycle (=720° C. A). The air-fuel ratio lines a, b, c in FIG. 3 respectively indicate pre-catalyst air-fuel ratios A/Ff detected when there is no variation, the air-fuel ratio deviates toward a rich side by the imbalance percentage of 20% in only one cylinder and the air-fuel ratio deviates toward a rich side by the imbalance percentage of 50% in only one cylinder. As is apparent from the graph, as the degree of variation increases, the amplitude of fluctuations in air-fuel ratio with respect to the stoichiometric air-fuel ratio increases.

Here, the imbalance percentage (%) is a parameter related to the degree of air-fuel ratio variation among the cylinders. That is, the imbalance percentage is a value that, when a deviation in fuel injection amount is occurring in only one cylinder among all the cylinders, indicates the percentage of deviation of the fuel injection amount of the cylinder (imbalance cylinder) in which the deviation of fuel injection amount is occurring from a fuel injection amount, that is, a reference injection amount, of each of the cylinders (balance cylinders) in which no deviation of fuel injection amount is occurring. Where the imbalance percentage is IB, the fuel injection amount of the imbalance cylinder is Qib and the fuel injection amount of each balance cylinder, that is, the reference injection amount, is Qs, IB=(Qib−Qs)/Qs. As the imbalance percentage IB increases, the deviation of fuel injection amount of the imbalance cylinder with respect to the fuel injection amount of each balance cylinder increases, and the degree of air-fuel ratio variation increases.

Incidentally, as the air-fuel ratio variation occurs among the cylinders and then fluctuations in exhaust gas air-fuel ratio occurs during one engine cycle as shown in FIG. 3, an oxidation-reduction reaction is repeated at short intervals at the upstream catalyst 11, and activation of the upstream catalyst 11 is facilitated. As a result, in comparison with a case where there is no air-fuel ratio variation among the cylinders, the temperature of the upstream catalyst 11 increases. Here, the upstream catalyst 11 has an oxygen storage ability (O₂ storage ability). The upstream catalyst 11 adsorbs and holds excessive oxygen in exhaust gas when the air-fuel ratio of supplied exhaust gas is leaner than the stoichiometric air-fuel ratio, while the upstream catalyst 11 releases adsorbed and held oxygen when the air-fuel ratio of supplied exhaust gas is richer than the stoichiometric air-fuel ratio. The also applies to the downstream catalyst 19. At this time, oxygen adsorption is an oxidation reaction, and oxygen release is a reduction reaction. As shown in FIG. 3, as the air-fuel ratio variation occurs among the cylinders, the air-fuel ratio of exhaust gas supplied to the upstream catalyst 11 changes between a lean air-fuel ratio and a rich air-fuel ratio during one engine cycle, so an oxidation-reduction reaction occurs each time, and the temperature of the upstream catalyst 11 increases.

FIG. 4 shows the relationship between an imbalance percentage (%) and a catalyst temperature (° C.) of the upstream catalyst 11. The triangular dots in FIG. 4 are data when the vehicle equipped with the internal combustion engine 1 travels at a constant speed of 120 km/h, and the rhombic dots in FIG. 4 are data when the vehicle equipped with the internal combustion engine 1 travels at a constant speed of 60 km/h. As is apparent from the graph, as the imbalance percentage (%) deviates from 0%, that is, as the degree of air-fuel ratio variation increases, the catalyst temperature tends to increase.

In the present embodiment, focusing on the correlation between the degree of air-fuel ratio variation (imbalance percentage) among the cylinders and the catalyst temperature, it is determined whether there is an abnormal air-fuel ratio variation among the cylinders on the basis of a catalyst temperature detected by the temperature sensor 21 (referred to as “detected catalyst temperature”) to thereby detect the abnormal variation.

Particularly, the feature of the present embodiment is that a temperature parameter is calculated on the basis of a detected catalyst temperature and then an abnormal air-fuel ratio variation among the cylinders is detected on the basis of the temperature parameter at the time when a predetermined period of time has elapsed after a cold start of the internal combustion engine 1.

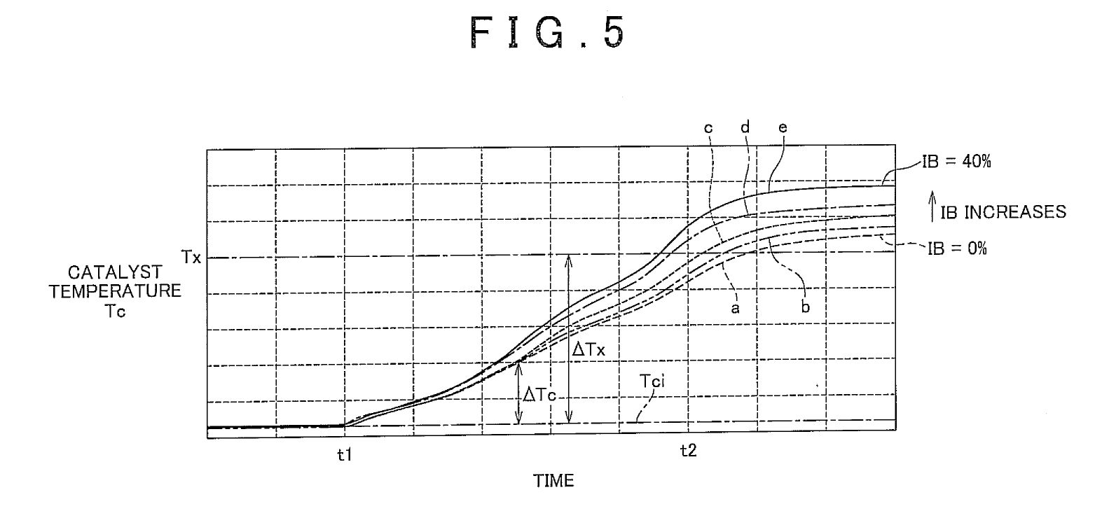

FIG. 5 shows changes of the catalyst temperature (detected catalyst temperature) after a cold start of the internal combustion engine 1. Time t1 is the time at which the internal combustion engine 1 is started in a cold state. After the start, the catalyst temperature gradually increases. At this time, as the degree of air-fuel ratio variation among the cylinders increases (that is, the imbalance percentage IB increases), the rate of increase in catalyst temperature increases. This is because, as described above, an oxidation-reduction reaction is further actively repeated in the catalyst as the degree of air-fuel ratio variation among the cylinders increases and, therefore, activation of the catalyst is facilitated.

Thus, in a simplest example, by comparing the detected catalyst temperature Tc with a predetermined determination temperature Tx, which is an abnormality determination value, at time t2 at which the predetermined period of time has elapsed from time t1 at which the internal combustion engine 1 is started in a cold state, it is possible to determine whether there is an abnormal air-fuel ratio variation among the cylinders. In this case, the detected catalyst temperature Tc itself is used as the temperature parameter, and a value equivalent to the detected catalyst temperature Tc is calculated as the temperature parameter.

In the example shown in FIG. 5, among the five lines a to e, it is determined that there is no abnormal air-fuel ratio variation among the cylinders for the lines a to c that are lower than the determination temperature Tx at time t2. This is because it may be determined that the rate of increase in catalyst temperature is low and the degree of air-fuel ratio variation among the cylinders is low. On the other hand, for the lines d and e that are higher than or equal to the determination temperature Tx at time t2, it is determined that there is an abnormal air-fuel ratio variation among the cylinders. This is because the rate of increase in catalyst temperature is higher than those of the lines a to c and it may be determined that the degree of air-fuel ratio variation among the cylinders is high.

The above method, particularly, has such a characteristic that the catalyst temperature after a cold start of the internal combustion engine 1 is considered. At the time of the cold start, the catalyst temperature is stable around an ambient temperature, so the initial condition of the catalyst temperature may be made uniform for each detection. Thus, it is possible to improve the accuracy of detecting an abnormal air-fuel ratio variation among the cylinders.

Here, the “at the time of a cold start” is the time when the internal combustion engine 1 is started under the condition that at least a predetermined period of time has elapsed after a previous stop of the internal combustion engine (the internal combustion engine is no longer in a warm-up state) and a representative temperature of the internal combustion engine 1, such as a coolant temperature and a fluid temperature, is lower than or equal to a predetermined value. Here, the predetermined value of the representative temperature may be set at a value that is slightly higher than a predetermined room temperature (for example, 20° C.). In contrast to the “cold start”, a start of the internal combustion engine in a warm-up state is called “hot start”.

An alternative example of abnormality detection may be as follows. That is, as shown in FIG. 5, a difference ΔTc between the detected catalyst temperature Tc and the initial value Tci is calculated as a temperature parameter. In addition, a difference ΔTx between the determination temperature Tx and the initial value Tci is used as an abnormality determination value that should be compared with the temperature parameter ΔTc. At time t2 at which the predetermined period of time has elapsed from the cold start time t1, when the temperature parameter ΔTc is smaller than the abnormality determination value ΔTx, it is determined that there is no abnormal air-fuel ratio variation among the cylinders; whereas, when the temperature parameter ΔTc is larger than or equal to the abnormality determination value ΔTx, it is determined that there is an abnormal air-fuel ratio variation among the cylinders. With the above method as well, the same results are obtained for the lines a to e.

Note that the upstream catalyst 11 receives supplied gas from the upstream end (front end) of the upstream catalyst 11, so the temperature gradually varies from the upstream end toward the downstream end (rear end). Thus, in order to immediately detect the variation in temperature of the upstream catalyst 11, the temperature detecting portion of the temperature sensor 21 is desirably located upstream of the middle position L/2 of the flow passage length L of the upstream catalyst 11 as in the case of the present embodiment and, more desirably, located at an upstream side as much as possible.

Incidentally, a reaction portion of the catalyst reduces as the catalyst degrades, and the catalyst temperature tends to decrease. Therefore, the above described rate of increase in catalyst temperature from the cold start also tends to decrease as the catalyst degrades. In addition, the catalyst temperature itself at the time when the predetermined period of time has elapsed after the cold start also tends to decrease as the catalyst degrades.

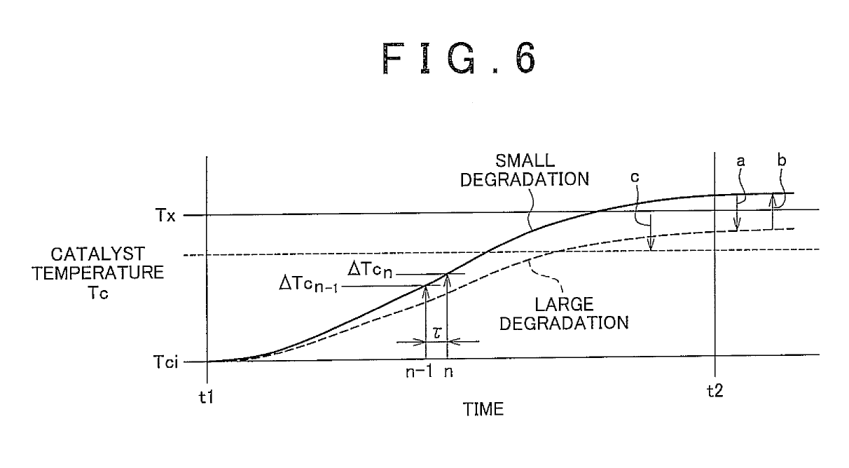

The above tendency is shown in FIG. 6. FIG. 6 is a time chart similar to that of FIG. 5. The solid line indicates the case of a catalyst having a low degree of degradation (low degradation catalyst), and the broken line indicates the case of a catalyst having a high degree of degradation (high degradation catalyst). As shown in the time chart, in the case of the high degradation catalyst, the rate of increase in catalyst temperature is lower than that in the case of the low degradation catalyst, and the catalyst temperature at time t2 at which the predetermined period of time has elapsed is also lower than that in the case of the low degradation catalyst. That is, the temperature characteristics of the high degradation catalyst shift toward a low temperature side from the temperature characteristics of the low degradation catalyst as indicated by the arrow “a”.

In this way, when taking into consideration the degree of degradation of the catalyst, it is possible to further improve detection accuracy, and it is also possible to further reduce the possibility that, although there is actually an abnormal air-fuel ratio variation among the cylinders, it is erroneously detected that there is no abnormal air-fuel ratio variation among the cylinders.

In the present embodiment, a catalyst degradation parameter related to the degree of degradation of the catalyst is measured. Then, the temperature parameter at the time at which the predetermined period of time has elapsed or the abnormality determination value is corrected in accordance with the measured catalyst degradation parameter. By so doing, the influence of the degree of degradation of the catalyst is removed to make it possible to improve detection accuracy.

When the temperature parameter is corrected, the temperature parameter is corrected toward a high temperature side as indicated by the arrow “b” in FIG. 6. In addition, when the abnormality determination value is corrected, the abnormality determination value is corrected toward a low temperature side as indicated by the arrow “c” in FIG. 6.

Here, various values may be employed as the catalyst degradation parameter. In the present embodiment, the oxygen storage capacity OSC of the catalyst is employed. Hereinafter, a method of measuring the oxygen storage capacity OSC of the catalyst will be described.

The upstream catalyst 11 and the downstream catalyst 19 according to the present embodiment each have an oxygen storage ability as described above. On the other hand, as the catalyst receives thermal stress to degrade over time, the oxygen storage ability of the catalyst decreases. There is a correlation between the degree of degradation of the catalyst and the degree of decrease in oxygen storage ability. Then, in the present embodiment, the oxygen storage capacity (OSC; O₂ Storage Capacity, in gram), which is the maximum amount of oxygen that can be stored by the current catalyst, is measured as the catalyst degradation parameter.

At the time of measuring the oxygen storage capacity, active air-fuel ratio control is executed. In the active air-fuel ratio control, the air-fuel ratio of an air-fuel mixture, that is, a pre-catalyst air-fuel ratio A/Ff, is alternately changed between a rich side and a lean side with respect to the stoichiometric air-fuel ratio.

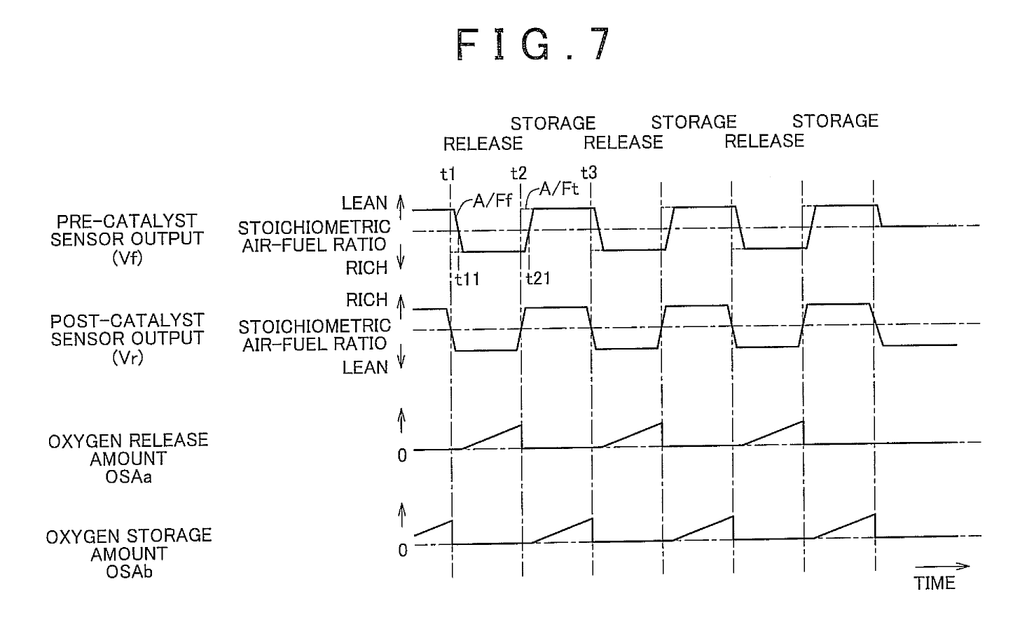

In FIG. 7, the time chart of the pre-catalyst sensor output Vf indicates the target air-fuel ratio A/Ft (broken line) and the pre-catalyst air-fuel ratio A/Ff (solid line) that is detected by the pre-catalyst sensor 17. In addition, the time chart of the post-catalyst sensor output Vr indicates the post-catalyst air-fuel ratio A/Fr. The time chart of the oxygen release amount OSAa indicates an accumulated amount of oxygen released from the upstream catalyst 11, that is, an accumulated oxygen release amount OSAa, and the time chart of the oxygen storage amount OSAb indicates an accumulated amount of oxygen stored in the catalyst, that is, an accumulated oxygen storage amount OSAb.

As shown in FIG. 7, by executing active air-fuel ratio control, the air-fuel ratio of exhaust gas flowing into the catalyst is forcibly changed at a predetermined timing alternately between a lean side and a rich side. For example, the target air-fuel ratio A/Ft is set to be leaner than the stoichiometric air-fuel ratio (for example, 15.0) before time t1, and lean gas flows into the upstream catalyst 11. At this time, the upstream catalyst 11 continues to absorb oxygen and then reduces and purifies NOx in exhaust gas; however, the upstream catalyst 11 cannot absorb oxygen any more at the time when the upstream catalyst 11 has absorbed oxygen to a saturated state, that is, to a full level, and lean gas passes through the upstream catalyst 11 and flows out to the downstream side of the upstream catalyst 11. Then, the output of the post-catalyst sensor 18 is inverted to a lean side, and the output of the post-catalyst sensor 18 reaches the stoichiometric air-fuel ratio corresponding value Vrefr (time t1). At this moment, the target air-fuel ratio A/Ft is changed to be richer than the stoichiometric air-fuel ratio (for example, 14.0).

Then, this time, rich gas flows into the upstream catalyst 11. At this time, the upstream catalyst 11 continues to release oxygen that has been stored till then to oxidize and purify rich substances (HC, CO) in exhaust gas; however, when all the stored oxygen has been finally released from the upstream catalyst 11, the upstream catalyst 11 cannot release oxygen any more at that moment, and then rich gas passes through the upstream catalyst 11 and flows to the downstream side of the upstream catalyst 11. Then, the post-catalyst air-fuel ratio changes to a rich side, and the output of the post-catalyst sensor 18 reaches the stoichiometric air-fuel ratio corresponding value Vrefr (time t2). At this moment, the target air-fuel ratio A/Ft is changed to a lean air-fuel ratio. In this way, the air-fuel ratio is repeatedly changed between a rich side and a lean side.

As shown in the time chart of the oxygen release amount OSAa, during a release cycle from time t1 to time t2, the oxygen release amount OSAa will be sequentially accumulated at extremely short predetermined intervals. More specifically, from time t11 at which the output of the pre-catalyst sensor 17 has reached the stoichiometric air-fuel ratio corresponding value to time t2 at which the output of the post-catalyst sensor 18 has been inverted to a lean side (reached Vrefr), the oxygen release amount dOSA (dOSAa) for each processing interval is calculated by the following mathematical expression (1), and the value of each processing interval will be accumulated at each interval. A final accumulated value obtained during one release cycle in this way becomes a measured oxygen release amount OSAa corresponding to the oxygen storage capacity of the catalyst.

dOSA=ΔA/F×Q×K=|A/Fs−A/Ff|−Q−K (1)

Q is a fuel injection amount, and A/Fs is a stoichiometric air-fuel ratio. An excessive or insufficient air amount may be calculated by multiplying the air-fuel ratio difference ΔA/F by the fuel injection amount Q. K is an oxygen rate (about 0.23) contained in air.

Similarly during a storage cycle from time t2 to time t3, as indicated by the time chart of the oxygen storage amount OSAb, from time t21 at which the output of the pre-catalyst sensor 17 has reached the stoichiometric air-fuel ratio corresponding value to time t3 at which the output of the post-catalyst sensor 18 has been inverted to a rich side (reached Vrefr), the oxygen storage amount dOSA (dOSAb) for each processing interval is calculated by the above mathematical expression (1), and the value of each processing interval will be accumulated at each interval. A final accumulated value obtained during one storage cycle in this way becomes a measured oxygen storage amount OSAb corresponding to the oxygen storage capacity of the catalyst. By repeating the release cycle and the storage cycle in this way, multiple oxygen release amounts OSAa and multiple oxygen storage amounts OSAb are measured and acquired.

As the catalyst becomes newer, a duration, during which the catalyst is able to continue releasing or storing oxygen, extends. Therefore, a large measured oxygen release amount OSAa or a large measured oxygen storage amount OSAb may be obtained. In addition, in principle, the amount of oxygen that the catalyst is able to release is equal to the amount of oxygen that the catalyst is able to store, so the measured oxygen release amount OSAa is substantially equal to the measured oxygen storage amount OSAb.

The average of the oxygen release amount OSAa and the oxygen storage amount OSAb that are measured during a pair of mutually adjacent release cycle and storage cycle is obtained, and is used as a unit of measured oxygen storage capacity for one storage/release cycle. Then, a plurality of units of measured oxygen storage capacity are obtained for multiple storage/release cycles, and the average of the plurality of units of measured oxygen storage capacity is calculated as a final measured oxygen storage capacity OSC.

Note that, other than the oxygen storage capacity OSC, for example, the output locus length, output area, or the like, of the post-catalyst sensor 18 during active air-fuel ratio control may be employed as the catalyst degradation parameter. During active air-fuel ratio control, as the degree of degradation of the catalyst increases, fluctuations in the output of the post-catalyst sensor 18 increase. This characteristic is utilized.

Incidentally, as the air-fuel ratio of exhaust gas supplied to the catalyst becomes leaner, the catalyst temperature tends to increase. Therefore, the rate of increase in catalyst temperature up to the time at which the predetermined period of time has elapsed after the cold start also tends to increase as the average air-fuel ratio of exhaust gas during the above period becomes leaner. In addition, the catalyst temperature itself at the time when the predetermined period of time has elapsed after the cold start also tends to increase as the average air-fuel ratio of exhaust gas becomes leaner.

The above tendency is shown in FIG. 8. FIG. 8 is a time chart similar to that of FIG. 5. The solid line indicates the case where the average air-fuel ratio is the stoichiometric air-fuel ratio, and the broken line indicates the case where the average air-fuel ratio is leaner than the stoichiometric air-fuel ratio. As shown in the time chart, in the case of a lean air-fuel ratio, the rate of increase in catalyst temperature is higher than that in the case of the stoichiometric air-fuel ratio, and the catalyst temperature at time t2 at which the predetermined period of time has elapsed is also high. That is, the temperature characteristics in the case of a lean air-fuel ratio shift toward a high temperature side as indicated by the arrow “a” from the temperature characteristics in the case of the stoichiometric air-fuel ratio.

In this way, in consideration of the average air-fuel ratio of exhaust gas, it is possible to further improve detection accuracy, and it is also possible to further reduce the possibility that, although there is actually no abnormal air-fuel ratio variation among the cylinders, it is erroneously detected that there is an abnormal air-fuel ratio variation among the cylinders.

Then, in the present embodiment, the average air-fuel ratio of exhaust gas supplied to the upstream catalyst 11 by time t2 at which the predetermined period of time has elapsed after time t1 at which the internal combustion engine is started in a cold state is measured. Then, the temperature parameter at the time when the predetermined period of time has elapsed or the abnormality determination value is corrected in accordance with the measured average air-fuel ratio. By so doing, the influence of the exhaust gas air-fuel ratio is removed to make it possible to improve detection accuracy.

When the temperature parameter is corrected while the average air-fuel ratio is leaner than the stoichiometric air-fuel ratio, the temperature parameter is corrected toward a low temperature side as indicated by the arrow “b” in FIG. 8. In addition, when the abnormality determination value is corrected, the abnormality determination value is corrected toward a high temperature side as indicated by the arrow “c” in FIG. 8.

There are various methods for measuring the average air-fuel ratio. The simplest method may be a method of simply averaging the air-fuel ratios detected by the pre-catalyst sensor 17 by time t2 at which the predetermined period of time has elapsed after time t1 at which the internal combustion engine is started in a cold state. On the other hand, as the degree of air-fuel ratio variation among the cylinders increases, the air-fuel ratio detected by the pre-catalyst sensor 17 deviates toward a rich side with respect to an actual value because of the influence of hydrogen in exhaust gas. Then, in consideration of the above characteristic, in the present embodiment, the air-fuel ratio of exhaust gas supplied to the upstream catalyst 11 is estimated by taking into consideration the air-fuel ratio detected by the post-catalyst sensor 18 that is not influenced by hydrogen, and then the estimated air-fuel ratio is averaged to measure the average air-fuel ratio.

Even when hydrogen is contained in exhaust gas supplied to the upstream catalyst 11, the hydrogen is oxidized and purified by the upstream catalyst 11 when passing through the upstream catalyst 11. Thus, it is presumable that the air-fuel ratio detected by the post-catalyst sensor 18 indicates an actual value without a deviation toward a rich side due to the influence of hydrogen. Then, the air-fuel ratio of gas supplied to the upstream catalyst 11 is estimated on the basis of the air-fuel ratio detected by the pre-catalyst sensor 17 and the air-fuel ratio detected by the post-catalyst sensor 18 to thereby make it possible to further accurately measure the average air-fuel ratio.

For example, the estimated air-fuel ratio A/Fe may be sequentially calculated by the following mathematical expression (2). Here, A/Ff is the pre-catalyst air-fuel ratio converted from the pre-catalyst sensor output Vf, A/Fr is the post-catalyst air-fuel ratio converted from the post-catalyst sensor output Vr, and α is a predetermined weighted coefficient that satisfies 0<α<1.

A/Fe=α×A/Ff+(1−α)×A/Fr (2)

Alternatively, there is another method that incorporates the auxiliary air-fuel ratio correction amount based on the air-fuel ratio detected by the post-catalyst sensor 18 into the air-fuel ratio detected by the pre-catalyst sensor 17. In auxiliary air-fuel ratio feedback control, a difference between the post-catalyst sensor output Vr and its stoichiometric air-fuel ratio corresponding value Vrefr is sequentially accumulated for a predetermined period of time. Then, the auxiliary air-fuel ratio correction amount is calculated on the basis of the above accumulated value. Thus, even when the auxiliary air-fuel ratio correction amount is incorporated, the estimated air-fuel ratio A/Fe may be obtained with high accuracy.

Incidentally, after an abnormal air-fuel ratio variation among the cylinders is detected (that is, after it is determined that there is an abnormal air-fuel ratio variation among the cylinders), if active air-fuel ratio control that forcibly increases or decreases the air-fuel ratio is executed, an oxidation-reduction reaction in the catalyst is further activated to further increase the catalyst temperature. Thus, there is a possibility that degradation or failure of the catalyst is facilitated.

Then, in the present embodiment, after an abnormal air-fuel ratio variation among the cylinders is detected, active air-fuel ratio control is prohibited. By so doing, degradation or failure of the catalyst may be suppressed.

The active air-fuel ratio control includes not only the above described active air-fuel ratio control executed when the oxygen storage capacity is measured but also active air-fuel ratio control executed at the time of an abnormality diagnosis of at least one of the pre-catalyst sensor 17 and the post-catalyst sensor 18, and the like. In addition, the active air-fuel ratio control includes rich control that forcibly makes the air-fuel ratio be rich after returning from fuel cut. If fuel cut and rich control are repeatedly carried out in a relatively short period of time, it leads to an increase in catalyst temperature due to a repeated oxidation-reduction reaction of the catalyst, so the above rich control is also included in a prohibiting target.

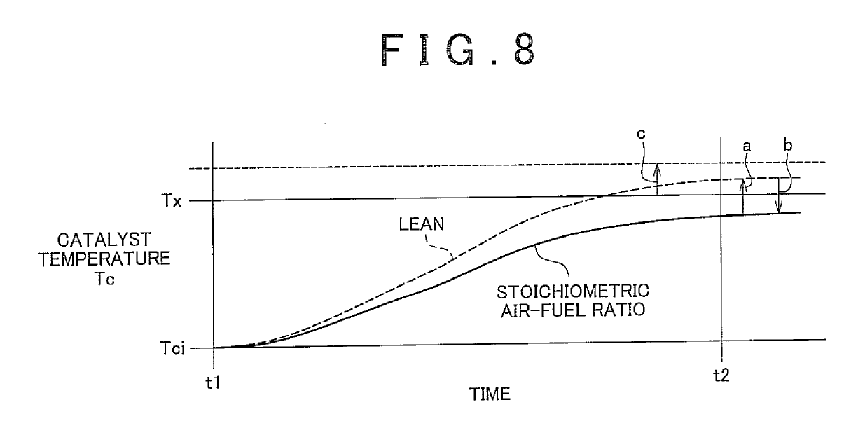

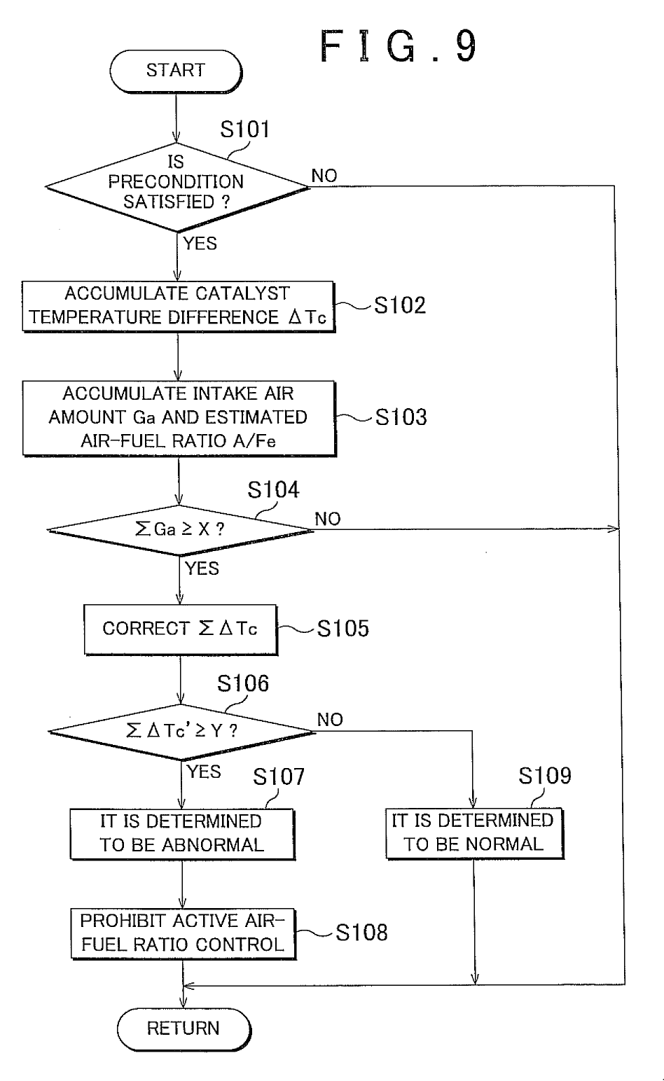

Next, the routine of detecting an abnormal air-fuel ratio variation among the cylinders will be described with reference to FIG. 9. The routine is repeatedly executed by the ECU 20 at predetermined processing intervals.

First, in step S101, it is determined whether a predetermined precondition suitable for detecting an abnormality is satisfied. The precondition is satisfied when the internal combustion engine 1 is started in a cold state. For example, as described above, when the internal combustion engine 1 is started under the condition that a predetermined period of time has elapsed after a previous stop of the internal combustion engine and the coolant temperature detected by the coolant temperature sensor 22 is lower than or equal to a predetermined value, the precondition is satisfied.

When the precondition is not satisfied, the routine ends. On the other hand, when the precondition is satisfied, the catalyst temperature difference ΔTc is accumulated in step S102. Here, the accumulated value of the catalyst temperature difference, that is, the accumulated catalyst temperature difference ΣΔTc, is used as the “temperature parameter”. By using the accumulated catalyst temperature difference ΣΔTc as the temperature parameter, it is possible to consider the way of increase in catalyst temperature, so it is advantageous to improvement of detection accuracy.

As described with reference to FIG. 5 and also shown in FIG. 6, the catalyst temperature difference ΔTc is a difference between the detected catalyst temperature Tc and its initial value Tci, and is a value obtained from ΔTc=Tc−Tci. The initial value Tci is the catalyst temperature Tc detected when the precondition is satisfied in step S101 for the first time.

As shown in FIG. 6, the catalyst temperature difference ΔTc is calculated and accumulated at each processing interval τ. Where a current value is denoted by n and a previous value is denoted by n−1, the accumulated catalyst temperature difference ΣΔTcₙ, calculated at the current processing timing is expressed by the following mathematical expression (3).

ΣΔTcₙ=ΣΔTcₙ₋₁+ΔTcₙ (3)

Subsequently, in step S103, the intake air amount Ga calculated by the air flow meter 5 and the estimated air-fuel ratio A/Fe estimated as described above are accumulated. Here, the time at which the accumulated value of the intake air amount, that is, the accumulated intake air amount ΣGa, has reached a predetermined value X or above is the “time at which the predetermined period of time has elapsed after a cold start of the internal combustion engine”. In this way, it is determined whether the predetermined period of time has elapsed on the basis of the accumulated intake air amount ΣGa. By so doing, the state of a load in process of an increase in catalyst temperature may be considered, so it is advantageous to improvement of detection accuracy.

In the next step S104, it is determined whether the accumulated intake air amount ΣGa has reached the predetermined value X. When the determination is negative, the routine ends; whereas, when the determination is affirmative, the routine proceeds to step S105.

In step S105, accumulation of the catalyst temperature difference ΔTc, intake air amount Ga and estimated air-fuel ratio A/Fe is terminated. Then, the accumulated catalyst temperature difference ΣΔTc at that moment is corrected by the measured oxygen storage capacity OSC and the average air-fuel ratio A/Fav obtained by dividing the accumulated estimated air-fuel ratio A/Fe by the number of samples.

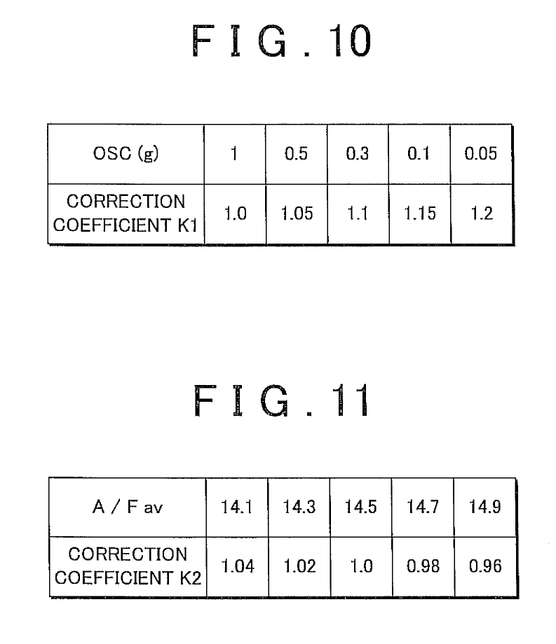

The last measured value is used as the oxygen storage capacity OSC. Then, a correction coefficient K1 corresponding to the oxygen storage capacity OSC is obtained from the map prestored in the ECU 20 as shown in FIG. 10. The correction coefficient K1 is a correction value multiplied by the accumulated catalyst temperature difference ΣΔTc. As is apparent from FIG. 10, the correction coefficient K1 increases as the oxygen storage capacity OSC reduces, and then the accumulated catalyst temperature difference ΣΔTc is corrected to a larger value. This is because, as described above, the rate of increase in catalyst temperature decreases as the degree of degradation of the catalyst increases and, therefore, the above correction is performed in order to compensate for this situation. In the example shown in FIG. 10, OSC=1 (g) and K1=1.0 in the case of a new catalyst, and K1 increases from 1.0 as the catalyst degrades from a new condition and, therefore, the OSC reduces.

In addition, a correction coefficient K2 corresponding to the average air-fuel ratio A/Fav is obtained from the map prestored in the ECU 20 as shown in FIG. 11. The correction coefficient K2 is also a correction value multiplied by the accumulated catalyst temperature difference ΣΔTc. As is apparent from FIG. 11, the correction coefficient K2 reduces as the average air-fuel ratio A/Fav becomes leaner, and the accumulated catalyst temperature difference ΣΔTc is corrected to a smaller value. This is because, as described above, the rate of increase in catalyst temperature increases as the air-fuel ratio of exhaust gas supplied to the catalyst becomes leaner and, therefore, the above correction is performed in order to compensate for this situation. In the example shown in FIG. 11, K2=1.0 when the average air-fuel ratio A/Fav is the stoichiometric air-fuel ratio=14.5, the value of K2 reduces as the average air-fuel ratio A/Fav deviates from the stoichiometric air-fuel ratio toward a lean side, and the value of K2 increases as the average air-fuel ratio A/Fav deviates from the stoichiometric air-fuel ratio toward a rich side.

When the correction coefficients K1 and K2 are obtained in this way, a corrected accumulated catalyst temperature difference ΣΔTc′ is calculated by the following mathematical expression (4).

ΣΔTc′=K1×K2×ΣΔTc (4)

Next, in step S106, the corrected accumulated catalyst temperature difference ΣΔTc′ is compared with a predetermined abnormality determination value Y.

When the corrected accumulated catalyst temperature difference ΣΔTc′ is smaller than the abnormality determination value Y, the routine proceeds to step S109 and then it is determined that there is no abnormal air-fuel ratio variation among the cylinders, that is, it is normal, after which the routine ends.

On the other hand, when the corrected accumulated catalyst temperature difference ΣΔTc′ is larger than or equal to the abnormality determination value Y, the routine proceeds to step S107 and then it is determined that there is an abnormal air-fuel ratio variation among the cylinders, that is, it is abnormal. In this case, the routine proceeds to step S108 to prohibit the following active air-fuel ratio control, after which the routine ends. Note that, in step S107, in synchronization with abnormality determination, an alarm device, such as a check lamp, may be activated in order to notify a user of the fact of abnormality.

The above described example is an example in which the accumulated catalyst temperature difference ΣΔTc, which is the temperature parameter, is corrected by both the oxygen storage capacity OSC and the average air-fuel ratio A/Fay. However, it is also applicable that the accumulated catalyst temperature difference ΣΔTc is corrected by only one of the oxygen storage capacity OSC and the average air-fuel ratio A/Fav or no correction is performed. In addition, as described above, it is also applicable that the abnormality determination value Y is corrected by at least one of the oxygen storage capacity OSC and the average air-fuel ratio A/Fay.

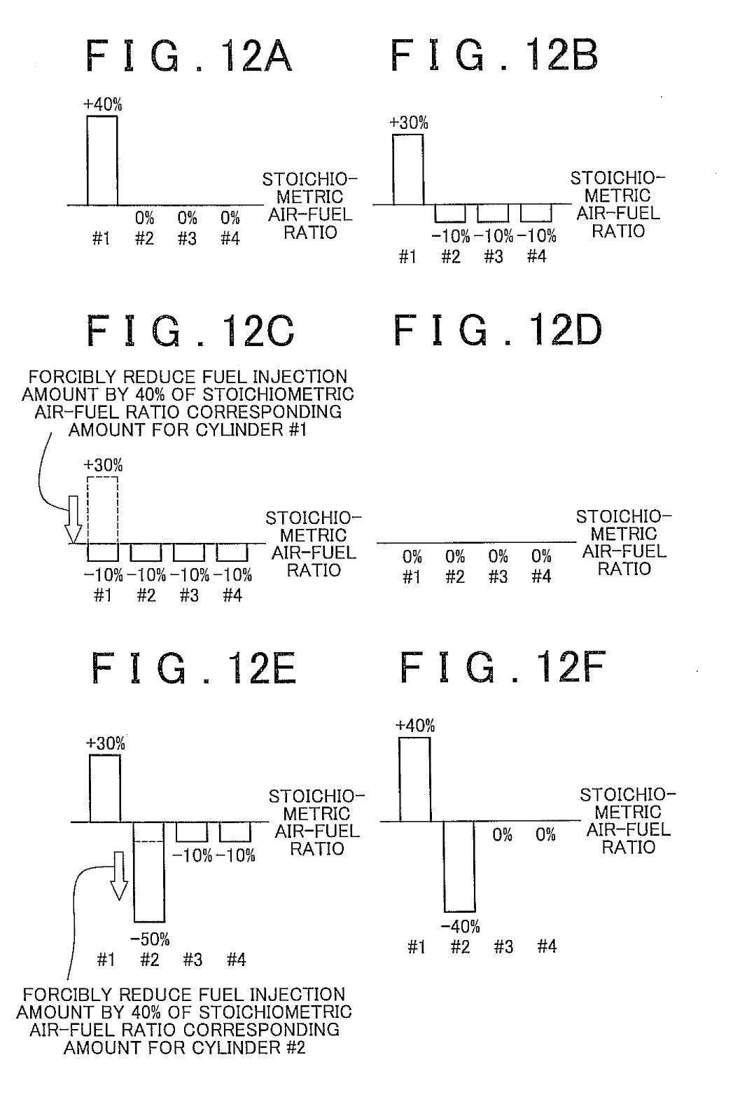

Incidentally, when an abnormal air-fuel ratio variation among the cylinders is detected, the cylinder (abnormal cylinder) that causes the abnormal variation may be identified. This is because, if the abnormal cylinder is identified, the following repair (for example, replacement of the injector, or the like) may be quickly and accurately performed. Then, in the present embodiment, an abnormal cylinder identifying unit is provided. The abnormal cylinder identifying unit forcibly increases or reduces the fuel injection amount for each cylinder when an abnormal air-fuel ratio variation among the cylinders is detected, and identifies an abnormal cylinder on the basis of a change in catalyst temperature detected during then. Hereinafter, the principle of abnormal cylinder identification will be described in detail with reference to FIG. 12A to FIG. 12F.

For example, as shown in FIG. 12A, it is assumed that the cylinder #1 is abnormal, the fuel injection amount of the cylinder #1 is higher by 40% than a stoichiometric air-fuel ratio corresponding amount (that is, the imbalance percentage is +40%) and the fuel injection amount of each of the other cylinders #2, #3 and #4 is the stoichiometric air-fuel ratio corresponding amount (that is, the imbalance percentage is 0%). At this time, when main and auxiliary air-fuel ratio controls are executed for a certain period of time, finally as shown in FIG. 12B, the imbalance percentage of the cylinder #1 is +30% and the imbalance percentage of each of the other cylinders #2, #3 and #4 is −10% so that the fuel injection amount in total becomes the stoichiometric air-fuel ratio corresponding amount. At this time as well, a plus or minus deviation in injection amount from the stoichiometric air-fuel ratio corresponding amount occurs in each cylinder. Thus, an oxidation-reduction reaction of the catalyst occurs during one engine cycle, and the catalyst temperature is higher than that when there is no deviation in injection amount in all the cylinders.

From the state shown in FIG. 12B, for example, as shown in FIG. 12C, the fuel injection amount of the cylinder #1 is forcibly reduced by 40% of the stoichiometric air-fuel ratio corresponding amount. By so doing, the imbalance percentage of the cylinder #1 becomes −10%, and is equal to the imbalance percentage of each of the other cylinders #2, #3 and #4.

In this state, when main and auxiliary air-fuel ratio controls are executed for a certain period of time while maintaining the reduced fuel injection amount of the cylinder #1, the fuel injection amount of each cylinder is finally corrected by +10% each as shown in FIG. 12D, and then the fuel injection amount of each cylinder becomes the stoichiometric air-fuel ratio corresponding amount (that is, the imbalance percentage of each cylinder is 0%). Thus, the catalyst temperature decreases to the level at which there is no deviation in injection amount in all the cylinders. For this reason, it is possible to identify a cylinder, due to which the catalyst temperature decreases by a predetermined value or above when the fuel injection amount is forcibly reduced, as an abnormal cylinder.

On the other hand, it is assumed that, from the state shown in FIG. 12B, for example, as shown in FIG. 12E, the fuel injection amount of the normal cylinder #2 is forcibly reduced by 40% of the stoichiometric air-fuel ratio corresponding amount. By so doing, the imbalance percentage of the cylinder #1 is +30% (unchanged), the imbalance percentage of the cylinder #2 is −50%, and the imbalance percentage of each of the cylinders #3 and #4 is −10% (unchanged).

In this state, when main and auxiliary air-fuel ratio controls are executed for a certain period of time while maintaining the reduced fuel injection amount of the cylinder #2, finally, the imbalance percentage of the cylinder #1 becomes +40%, the imbalance percentage of the cylinder #2 becomes −40% and the imbalance percentage of each of the cylinders #3 and #4 becomes 0% so that the total fuel injection amount becomes the stoichiometric air-fuel ratio corresponding amount as shown in FIG. 12F. In this case as well, an oxidation-reduction reaction of the catalyst occurs during one engine cycle, and the catalyst temperature increases as compared with when there is no deviation in injection amount in all the cylinders. For this reason, it is possible to identify a cylinder, due to which the catalyst temperature does not decrease by a predetermined value or above when the fuel injection amount is forcibly reduced, not as an abnormal cylinder but as a normal cylinder.

Although not shown in the drawing, in the inverse pattern, it is assumed that, for example, in the example shown in FIG. 12A, only the cylinder #1 is abnormal and the fuel injection amount is smaller by −40% than the stoichiometric air-fuel ratio corresponding amount (that is, the imbalance percentage is −40%). Then, when the fuel injection amount is forcibly increased for each cylinder, it is possible to identify a cylinder, due to which the catalyst temperature decreases by a predetermined value or above, as an abnormal cylinder and a cylinder, due to which the catalyst temperature does not decrease by a predetermined value or above, as a normal cylinder.

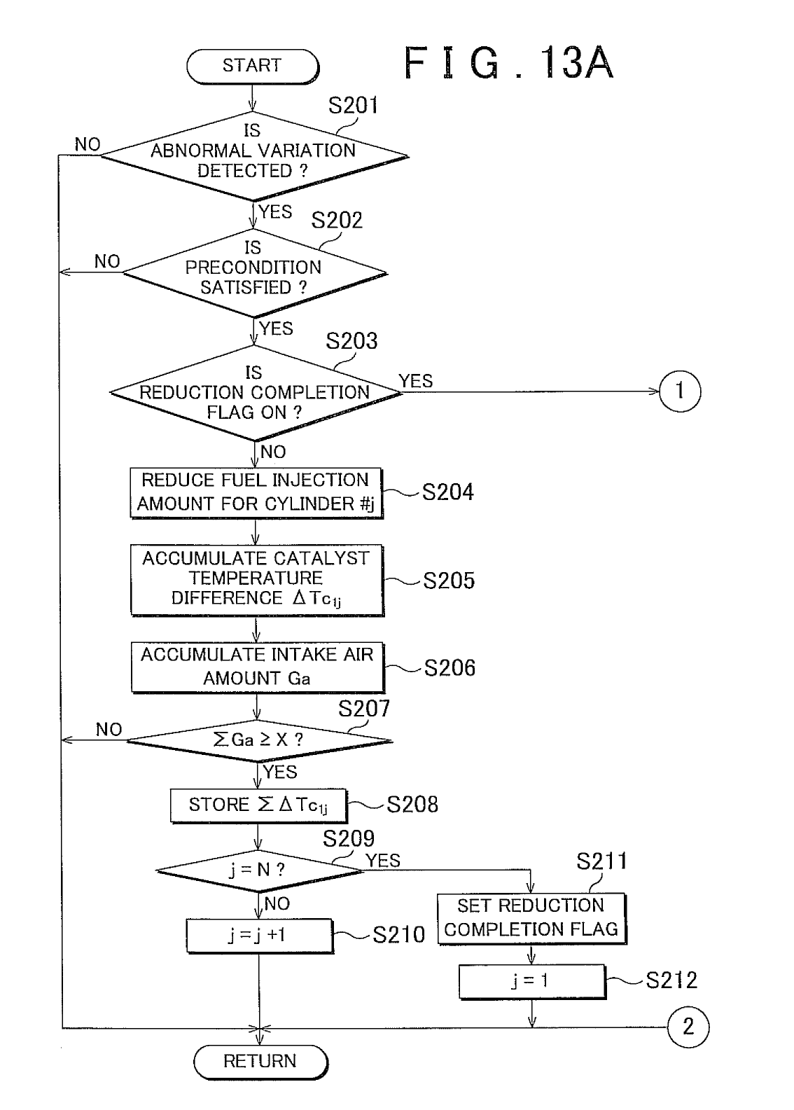

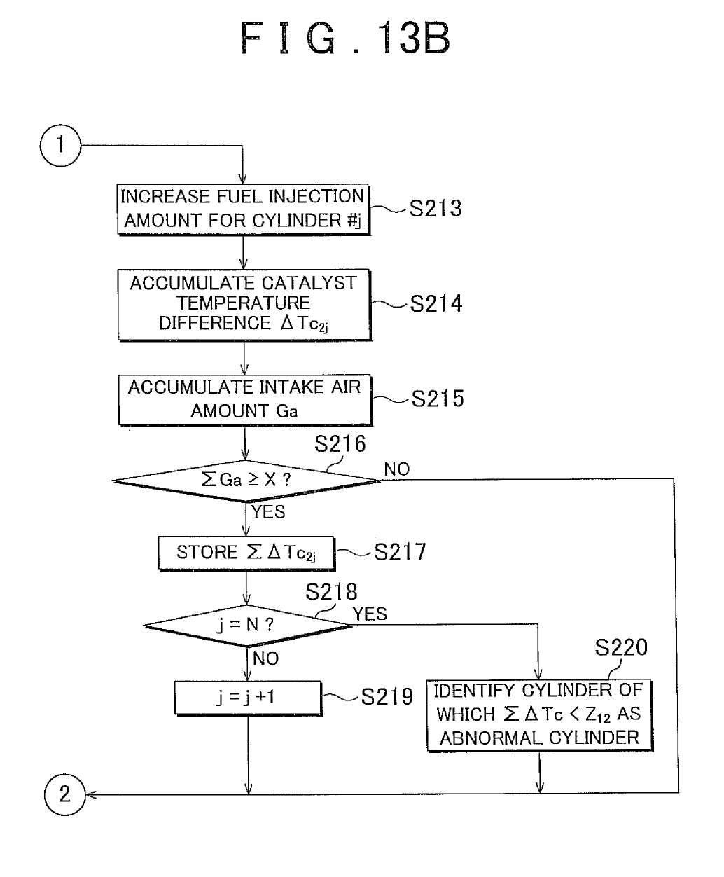

Hereinafter, an abnormal cylinder identification routine according to the above principle will be described with reference to FIG. 13A and FIG. 13B. The routine is also repeatedly executed by the ECU 20 at predetermined processing intervals. The routine is executed while executing main and auxiliary air-fuel ratio controls (stoichiometric air-fuel ratio F/B control) that set the stoichiometric air-fuel ratio as a target air-fuel ratio.

First, in step S201, it is determined whether an abnormal air-fuel ratio variation among the cylinders is detected, that is, it is determined whether abnormality determination in step S107 of FIG. 9 is performed. When no abnormal variation is detected, the routine ends. On the other hand, when an abnormal variation is detected, it is determined in step S202 whether the predetermined precondition is satisfied. Here, the precondition is satisfied when an idle operation duration measured separately has reached a predetermined period of time or longer. That is, abnormal cylinder identification is carried out during idle operation of the engine.

When the precondition is not satisfied, the routine ends. On the other hand, when the precondition is satisfied, it is determined in step S203 whether a reduction completion flag is on. As will be understood from the following description, the reduction completion flag is set when forcible reduction in fuel injection amount for all the cylinders is completed, and the reduction completion flag is cleared other than the above.

When the reduction completion flag is not on, the routine proceeds to step S204 and then the fuel injection amount of each cylinder is forcibly reduced. On the other hand, when the reduction completion flag is on, the process proceeds to step S213 and then the fuel injection amount of each cylinder is forcibly increased. Here, the fuel injection amount is reduced first, and subsequently the fuel injection amount is increased.

When the reduction in fuel injection amount will be described first, the fuel injection amount Q of a cylinder #j is forcibly reduced by a predetermined amount in step S204. j denotes a cylinder number (j=1, 2, 3, 4), and the initial value of j is 1. For example, the fuel injection amount Q is forcibly reduced by H₁% (for example, H₁=20) of the basic injection amount Qb that is the stoichiometric air-fuel ratio corresponding amount. In other words, the basic injection amount Qb is replaced by a value reduced by H₁%, that is, Qb×(1−H₁/100).

Next, in step S205, as in the case of step S102, the catalyst temperature difference ΔTc₁ⱼ is accumulated. The catalyst temperature difference ΔTc₁ⱼ is obtained from ΔTc₁ⱼ=Tc−Tci, and the initial value Tci is the catalyst temperature Tc detected when forcible reduction is started for the cylinder #j. Here, when forcible reduction is carried out for the abnormal cylinder, the catalyst temperature gradually decreases, so a negative value is obtained as the catalyst temperature difference ΔTc₁ⱼ. Thus, the accumulated catalyst temperature difference ΣΔTc₁ⱼₙ obtained from the above mathematical expression (3) also gradually increases in a minus direction.

Subsequently, in step S206, the intake air amount Ga detected by the air flow meter 5 is accumulated, and it is determined in step S207 whether the accumulated intake air amount ΣGa has reached a predetermined amount X or above. When the determination is negative, the routine ends; whereas, when the determination is affirmative, the routine proceeds to step S208.

In step S208, accumulation of the catalyst temperature difference ΔTc₁ⱼ and accumulation of the intake air amount Ga are terminated, and the accumulated catalyst temperature difference ΣΔTc₁ⱼ, which is the final accumulated catalyst temperature difference ΔTc₁ⱼ, is stored in the ECU 20.

In this way, the accumulated catalyst temperature difference ΣΔTc₁ⱼ is acquired when a predetermined period of time (the accumulated intake air amount ΣGa reaches the predetermined value X or above) has elapsed after a start of reduction in fuel injection amount. This is, for example, to wait that the state of FIG. 12C is changed into the state of FIG. 12D, that is, the state at the time of a start of reduction in fuel injection amount is changed into a state where the fuel injection amount has been corrected through stoichiometric air-fuel ratio F/B control. Furthermore, this is to wait that the catalyst temperature becomes a temperature corresponding to a corrected state.

Subsequently, in step S209, it is determined whether the cylinder number j has reached N (four in the present embodiment) that indicates the number of cylinders. When j is not equal to N, the routine proceeds to step S210, and the value of j is increased by 1 (j=j+1), after which the routine ends.

On the other hand, when j is equal to N, the routine proceeds to step S211 to set the reduction completion flag, and the value of j is returned to the initial value 1 in step S212, after which the routine ends.

Then, the determination result of step S203 is affirmative, the routine of increasing the fuel injection amount is executed this time. The details of the routine of increasing the fuel injection amount is almost the same as that of the routine of reducing the fuel injection amount.

In step S213, the fuel injection amount Q of the cylinder #j is forcibly increased by a predetermined amount. For example, the fuel injection amount Q is forcibly increased by H₂% (for example, H₂=40) of the basic injection amount Qb that is the stoichiometric air-fuel ratio corresponding amount. In other words, the value of the basic injection amount Qb is replaced by a value increased by H₂%, that is, Qb×(1+H₂/100).

The increase percentage H₂ is higher than the reduction percentage H₁; conversely, the reduction percentage H₁ is lower than the increase percentage H₂. This is because there is a possibility that a misfire occurs at the reduction side in an imbalance lower than that at the increase side.

Next, in step S214, the catalyst temperature difference ΔTc₂ⱼ is accumulated. At the time of increasing the fuel injection amount as well, the accumulated catalyst temperature difference ΣΔTc₂ⱼₙ gradually increases in a minus direction in the abnormal cylinder.

Subsequently, the intake air amount Ga detected in step S215 is accumulated, and it is determined in step S216 whether the accumulated intake air amount ΣGa has reached the predetermined amount X or above. When the determination is negative, the routine ends; whereas, when the determination is affirmative, the routine proceeds to step S217.

In step S217, accumulation of the catalyst temperature difference ΔTc₂ⱼ and accumulation of the intake air amount Ga are terminated, and the accumulated catalyst temperature difference ΣΔTc₂ⱼ, which is the final accumulated catalyst temperature difference ΔTc₂ⱼ, is stored in the ECU 20.

Subsequently, in step S218, it is determined whether the cylinder number j has reached N. When j is not equal to N, the routine proceeds to step S219, and the value of j is increased by 1, after which the routine ends.

On the other hand, when j is equal to N, the routine proceeds to step S220, and the abnormal cylinder is identified. Specifically, the stored values of the accumulated catalyst temperature differences ΣΔTc₁ⱼ and ΣΔTc₂ⱼ of each cylinder are sequentially compared with a predetermined threshold Z₁₂. Here, the threshold Z₁₂ is a minus value. Then, the cylinders are searched for a cylinder of which ΣΔTc₁ⱼ<Z₁₂ or ΣΔTc₂ⱼ<Z₁₂ is satisfied. When there is the cylinder of which ΣΔTc₁ⱼ<Z₁₂ or ΣΔTc₂ⱼ<Z₁₂ is satisfied, that cylinder is identified as the abnormal cylinder. In synchronization with the abnormal cylinder identification, the cylinder number of that abnormal cylinder is stored in the ECU 20 for repair, or the like, later. Then, the routine ends.

Note that, alternatively, the abnormal cylinder may be identified by comparing the accumulated catalyst temperature difference ΣΔTc₁ⱼ during reduction in fuel injection amount and the accumulated catalyst temperature difference ΣΔTc₂ⱼ during increase in fuel injection amount are respectively compared with different thresholds. In addition, more simply, the abnormal cylinder may be identified by comparing a difference between the catalyst temperature at the time of a start of reduction or increase in fuel injection amount and the catalyst temperature after a lapse of a predetermined period of time with a predetermined threshold. It is also applicable that only any one of reduction and increase in fuel injection amount is performed.

The embodiment of the invention is described above in detail; however, various alternative embodiments of the invention are conceivable. For example, the number of temperature sensors that detect the catalyst temperature is not limited to one.

Incidentally, in recent years, an internal combustion engine (bifuel engine) that is able to use an alcohol as an alternative fuel in addition to a gasoline fuel at the same time is practically used. An automobile (flexible fuel vehicle (FFV)) equipped with such an internal combustion engine is able to travel not only by gasoline but also by blended fuel of alcohol and gasoline or only by alcohol.

As described above, when an abnormal air-fuel ratio variation among the cylinders is detected on the basis of a temperature parameter at the time when a predetermined period of time has elapsed after a cold start of the internal combustion engine, it has been found that, in the case of a fuel containing alcohol (hereinafter, referred to as alcohol fuel), the temperature parameter at the time when the predetermined period of time has elapsed varies in comparison with the case of a fuel not containing alcohol (hereinafter, referred to as gasoline fuel).

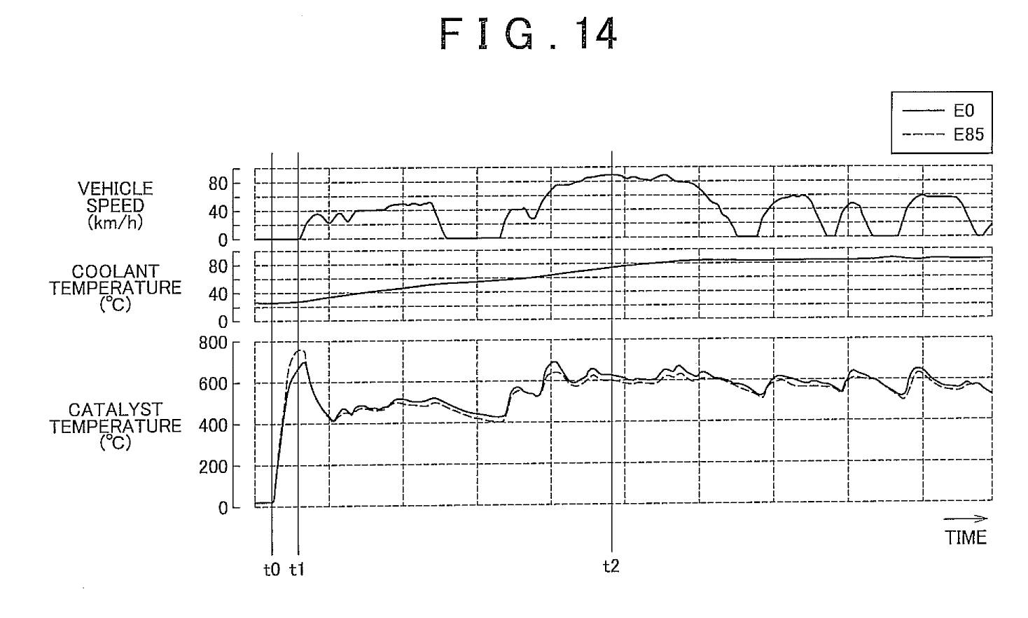

This fact is shown in FIG. 14. FIG. 14 shows changes in vehicle speed, coolant temperature and catalyst temperature when the FFV is caused to travel after a cold start of the engine. Time t0 is the time at which the engine is cold-started. In the time chart that shows changes in catalyst temperature, the solid line indicates the case of a gasoline fuel (E0), and the broken line indicates the case of an alcohol fuel. Particularly, a blended fuel (E85) of gasoline and alcohol is used as the alcohol fuel. In the blended fuel, 85% ethanol is blended.

Time t1 is the time at which several tens of seconds have elapsed after time t0, and is the timing that is suitable for acquiring the temperature parameter in the present embodiment. That is, in the present embodiment, an abnormal air-fuel ratio variation among the cylinders is detected on the basis of the degree of increase in catalyst temperature within a predetermined period t0 to t1 immediately after a cold start of the engine. Focusing on the predetermined period t0 to t1, as shown in the time chart that indicates changes in catalyst temperature, the rate of increase in exhaust temperature and catalyst temperature is higher in the case of an alcohol fuel than in the case of a gasoline fuel. This is presumably due to a difference in vaporization characteristic and burning rate between both fuels.

In the case of an internal combustion engine that is able to solely use an alcohol or a gasoline as a fuel or use a blend of alcohol and gasoline as a fuel or in the case of a vehicle equipped with the internal combustion engine, that is, an FFV, an erroneous determination or an erroneous detection may occur unless a difference in alcohol concentration of fuel is considered. Then, correction is carried out in accordance with an alcohol concentration of fuel to prevent an erroneous determination or an erroneous detection due to a difference in alcohol concentration of fuel. By so doing, it is possible to carry out accurate detection even for a bifuel engine or an FFV.

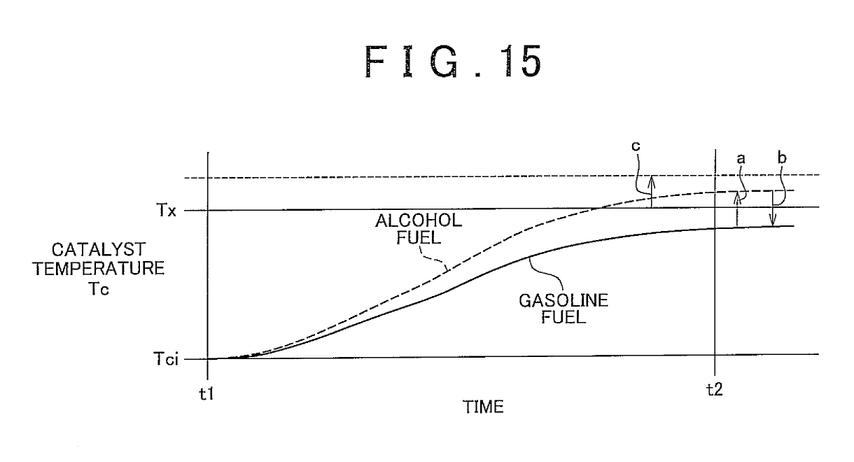

The outline of correction of alcohol concentration is substantially similar to the above described correction in accordance with an average air-fuel ratio. That is, as the alcohol concentration of fuel increases, the catalyst temperature at the time when a predetermined period of time has elapsed after a cold start of the engine tends to increase, and the rate of increase in catalyst temperature during a period until that time also tends to increase. FIG. 15 is a graph in which “stoichiometric air-fuel ratio” in FIG. 8 is replaced with “gasoline fuel” and “lean air-fuel ratio” in FIG. 8 is replaced with “alcohol fuel”. As shown in the graph, the temperature characteristics in the case of an alcohol fuel shift toward a high temperature side as indicated by the arrow “a” from the temperature characteristics in the case of a gasoline fuel.

The temperature parameter at time t2 at which the predetermined period of time has elapsed after time t1 at which the internal combustion engine is cold-started or the abnormality determination value is corrected in accordance with the detected or estimated alcohol concentration of fuel. When the temperature parameter is corrected while the alcohol concentration is higher than 0%, the temperature parameter is corrected toward a low temperature side as indicated by the arrow “b” in FIG. 15. In addition, when the abnormality determination value is corrected, the abnormality determination value is corrected toward a high temperature side as indicated by the arrow “c” in FIG. 15.

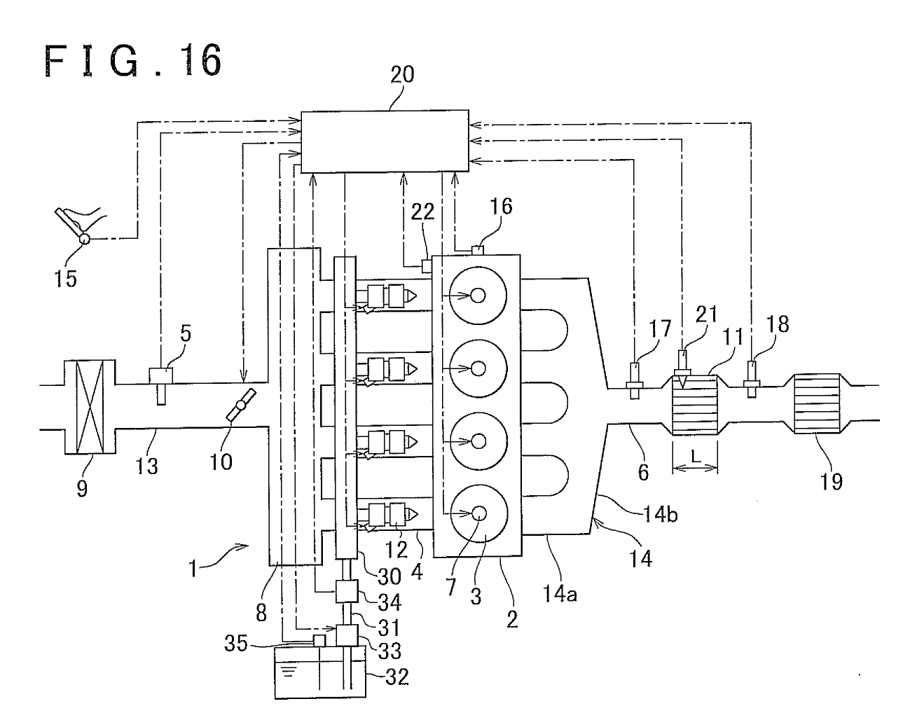

FIG. 16 shows the configuration of an internal combustion engine when the alcohol concentration is corrected. The configuration is substantially similar to the configuration shown in FIG. 1. Like reference numerals denote similar components, and the description thereof is omitted. Hereinafter, the difference will be specifically described.

A common delivery pipe 30 that supplies fuel to the injectors 12 of the respective cylinders is connected to a fuel tank 32 via a fuel pipe 31. A fuel pump 33 and an alcohol concentration sensor 34 are provided for the fuel pipe 31. The fuel pump 33 is used to supply fuel in the fuel tank 32 to the delivery pipe 30. The alcohol concentration sensor 34 detects the alcohol concentration of fuel. A fuel level sensor 35 (for example, sender gauge) is provided for the fuel tank 32. The fuel level sensor 35 is used to detect the fuel level in the fuel tank 32. The fuel pump 33, the alcohol concentration sensor 34 and the fuel level sensor 35 each are electrically connected to the ECU 20.

The alcohol concentration sensor 34 may be, for example, of a capacitance type that detects the alcohol concentration on the basis of the dielectric constant of fuel or an optical type that detects the alcohol concentration on the basis of the refraction index of light in fuel. In the present embodiment, the alcohol concentration sensor 34 is provided for the fuel pipe 31; instead, the alcohol concentration sensor 34 may be installed in any locations in a fuel path, such as the fuel tank 32 and the delivery pipe 30.

Note that the alcohol concentration of fuel is directly detected by the alcohol concentration sensor 34 here; instead, the alcohol concentration of fuel may be estimated. The estimating method is already known, and, for example, methods described in Japanese Patent Application Publication No. 2007-303389 (JP-A-2007-303389), Japanese Patent Application Publication No. 2009-222014 (JP-A-2009-222014) and Japanese Patent Application Publication No. 2009-228592 (JP-A-2009-228592) may be employed. In addition, it is conceivable that the ECU 20 learns the detected alcohol concentration or the estimated alcohol concentration, and it is possible to correct the alcohol concentration on the basis of the learned value.

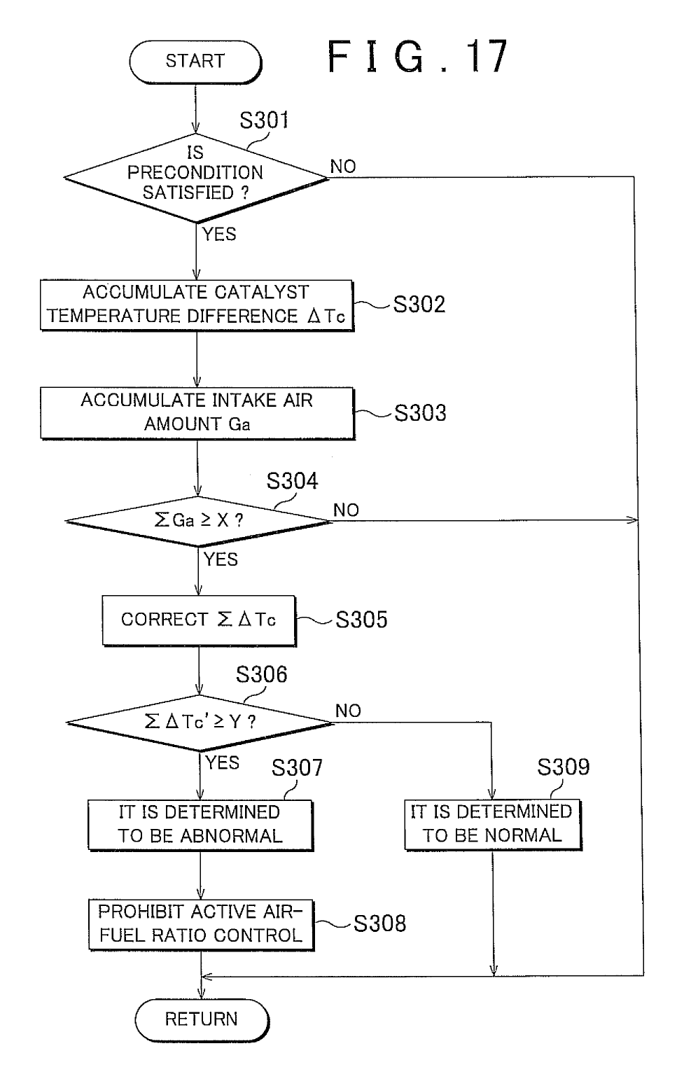

The routine of detecting an abnormal air-fuel ratio variation among the cylinders involving correction of the alcohol concentration will be described with reference to FIG. 17. The routine is repeatedly executed by the ECU 20 at predetermined processing intervals.

Steps S301 and S302 are the same as steps S101 and S102 shown in FIG. 9. In step S303, as in the case of step S103, the intake air amount Ga is accumulated; however, the estimated air-fuel ratio A/Fe is not accumulated. That is, here, correction in accordance with an average air-fuel ratio is not performed. However, the estimated air-fuel ratio A/Fe may be accumulated. Step S304 is the same as step S104. In step S304, it is determined whether the accumulated intake air amount ΣGa has reached the predetermined value X. When the determination is negative, the routine ends; whereas, when the determination is affirmative, the routine proceeds to step S305.

In step S305, as in the case of step S105, accumulation of the catalyst temperature difference ΔTc and intake air amount Ga is terminated. Then, the accumulated catalyst temperature difference ΣΔTc at that moment is corrected on the basis of the oxygen storage capacity OSC, which serves as the catalyst degradation parameter, and the alcohol concentration of fuel.

A correction method based on the oxygen storage capacity OSC is as described above, and a correction coefficient K1 corresponding to the oxygen storage capacity OSC is calculated from the map shown in FIG. 10.

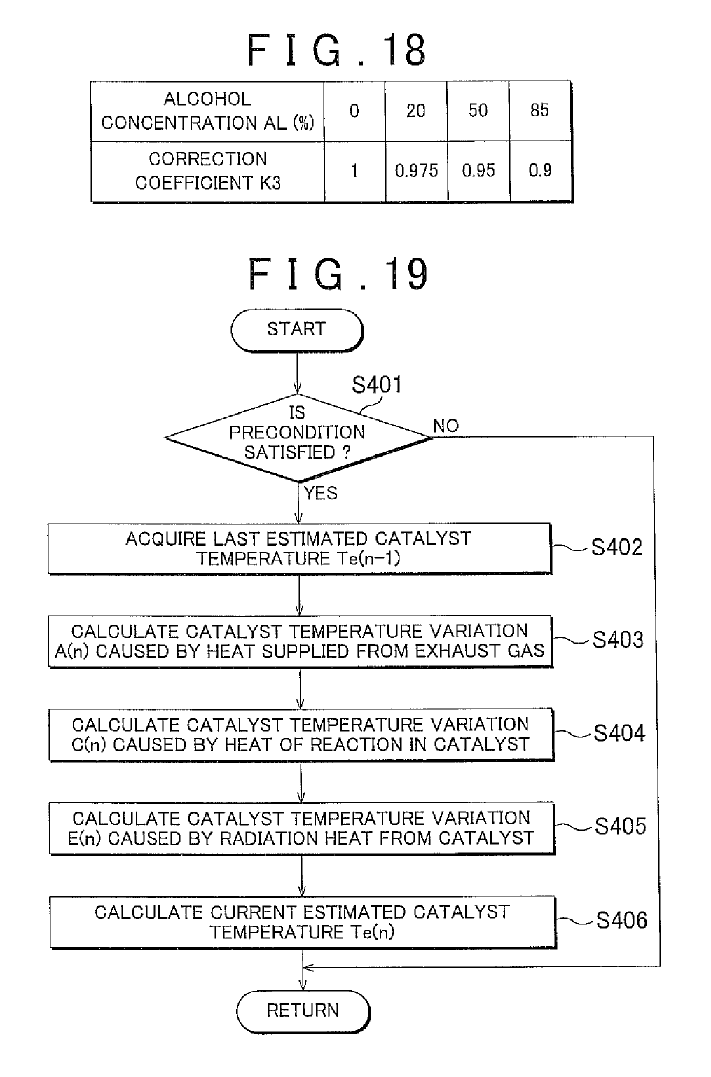

As for correction based on the alcohol concentration of fuel, a correction coefficient K3 corresponding to an alcohol concentration AL (for example, ethanol concentration) detected by the alcohol concentration sensor 34 is obtained from the map prestored in the ECU 20 as shown in FIG. 18. The correction coefficient K3 is a correction value multiplied by the accumulated catalyst temperature difference EAR. As is apparent from FIG. 18, the correction coefficient K3 reduces as the alcohol concentration increases, and the accumulated catalyst temperature difference ΣΔTc is corrected to a smaller value. This is because the rate of increase in catalyst temperature increases as the alcohol concentration increases and, therefore, the above correction is performed in order to compensate for this situation. In the example shown in FIG. 18, K3=1.0 when the alcohol concentration AL is 0(%) (that is, during usage of gasoline fuel), and K3 reduces from 1.0 as the alcohol concentration AL increases from 0(%).

When the correction coefficients K1 and K3 are obtained in this way, a corrected accumulated catalyst temperature difference ΣΔTc′ is calculated by the following mathematical expression (5).

ΣΔTc′=K1×K3×ΣΔTc (5)

Steps S306 to S308 thereafter are the same as steps S106 to S108. Note that, in an alternative embodiment, it is also applicable that no correction based on the oxygen storage capacity OSC is performed.

Incidentally, if a new fuel having an alcohol concentration different from that of a previous fuel present in the fuel tank 32 is filled into the fuel tank 32, the alcohol concentration of fuel in the fuel tank 32 varies. Immediately after fuel filling or fuel replacement, the previous fuel still remains in the fuel pipe 31, the delivery pipe 30 and the injectors 12, and the influence of the previous fuel does not disappear until the internal combustion engine is continuously operated for a certain period of time and the previous fuel is injected from the injectors 12 and consumed.

Particularly, in a state where the alcohol concentration of the new fuel is detected by the alcohol concentration sensor 34 and the previous fuel is injected from the injectors 12, the alcohol concentration of the actually injected fuel is different from the alcohol concentration of the detected fuel. If the alcohol concentration is corrected in this state, correction may be inappropriate, and this may lead to an erroneous determination or an erroneous detection.

Then, it is more desirable to prohibit or stop diagnosis during a predetermined period of time after fuel filling. By so doing, it is possible to prevent an erroneous determination or an erroneous detection.

Specifically, in step S301 (FIG. 17), the condition for satisfying the precondition includes a condition that the predetermined period of time has elapsed after fuel filling. It is conceivable that a period of time from the next start of the engine after fuel filling to when a predetermined amount of fuel is consumed and the influence of the previous fuel disappears (that is, the alcohol concentration of the actually injected fuel coincides with the alcohol concentration of the detected fuel) is set as the predetermined period of time. The predetermined period of time may be simply defined by a period of time after a start of the engine or may be defined by an accumulated amount of injected fuel after a start of the engine. Determination as to whether fuel filling is performed may be made by determining whether the value detected by the fuel level sensor 35 has increased by a predetermined value or above.

In this way, when diagnosis during a cold start of the engine immediately after fuel filling is prohibited or stopped, it is conceivable to detect an abnormal air-fuel ratio variation after completion of warm-up of the internal combustion engine in terms of ensuring a chance of detection. Then, hereinafter, an example of detection after completion of warm-up of the engine will be described.

In short, detecting an abnormal air-fuel ratio variation among the cylinders after completion of warm-up of the engine is to detect an abnormal air-fuel ratio variation among the cylinders on the basis of the detected catalyst temperature and the catalyst temperature estimated on the basis of an engine operating state after completion of warm-up of the internal combustion engine.

As described above, as the air-fuel ratio variation occurs among the cylinders, the catalyst temperature increases, and, as the degree of variation increases, the degree of increase in catalyst temperature also increases. Here, an actual catalyst temperature is detected by the temperature sensor 21 that serves as a catalyst temperature detecting unit, and the ECU 20 estimates the catalyst temperature on the basis of an engine operating state. The estimated catalyst temperature is irrelevant to the degree of air-fuel ratio variation among the cylinders. On the other hand, the detected catalyst temperature reflects the degree of air-fuel ratio variation among the cylinders. As an abnormal air-fuel ratio variation occurs among the cylinders, the estimated catalyst temperature significantly deviates from the detected catalyst temperature. Therefore, using this fact, an abnormal air-fuel ratio variation among the cylinders is detected on the basis of the detected catalyst temperature and the estimated catalyst temperature.

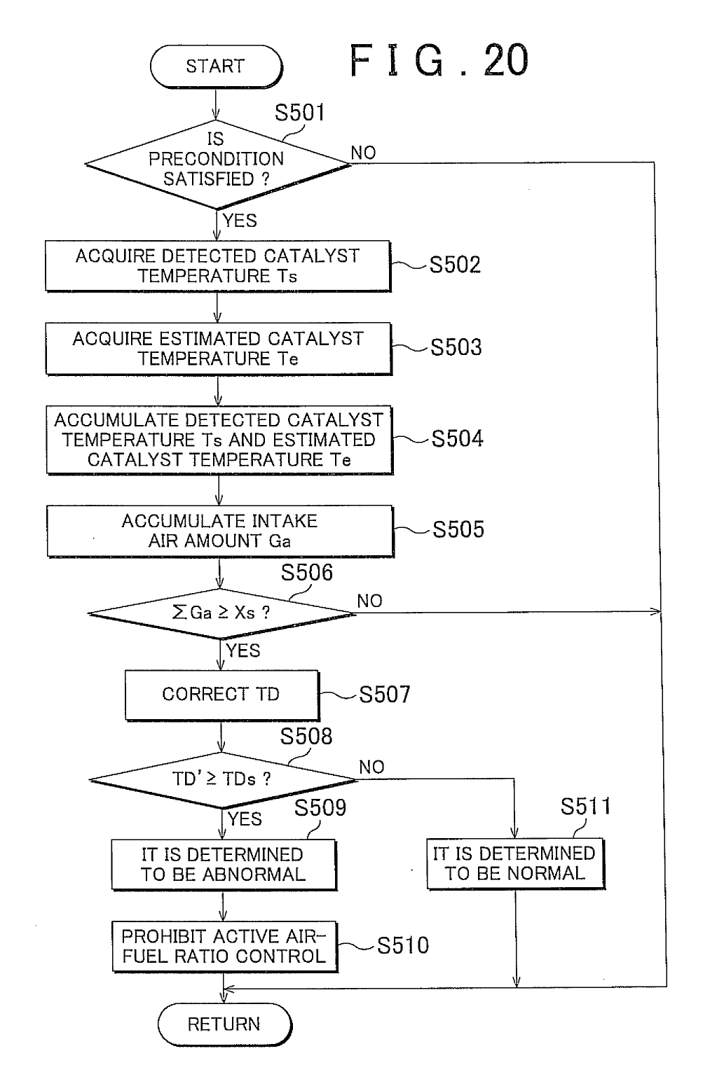

First, estimation of the catalyst temperature will be described. FIG. 19 shows the routine for estimating the temperature of the upstream catalyst 11. The routine is repeatedly executed by the ECU 20 at predetermined processing intervals.

First, in step S401, it is determined whether a predetermined precondition for estimating the catalyst temperature is satisfied. For example, the precondition is satisfied after the engine is started and when the coolant temperature detected by a coolant temperature sensor (not shown) is higher than a predetermined temperature (for example, −40° C.). Note that the precondition is not limited to this example. When the precondition is not satisfied, the routine ends; whereas, when the precondition is satisfied, the process proceeds to step S402.

In step S402, an estimated catalyst temperature calculated in the last routine (n−1), that is, an estimated catalyst temperature Te(n−1), is acquired.

Subsequently, in step S403, a catalyst temperature variation A(n) caused by heat supplied from exhaust gas in the current routine (n) is calculated. The catalyst temperature variation A(n) is obtained by the following mathematical expression (6).

A(n)=A(n−1)+{L1·(B−Te(n−1))−A(n−1)}/L2 (6)

L1 is a predetermined value that may be determined by adaptation, or the like. L2 is a predetermined smoothing rate that is preset as a value larger than 1. B is a parameter that varies with an intake air amount Ga (air amount parameter), and is determined on the basis of the intake air amount Ga detected by the air flow meter 5 in accordance with a predetermined map (which may be replaced with a function, and this also applies to the following description). A larger air amount parameter B is obtained as the intake air amount Ga increases. The air amount parameter B is a main parameter that indicates the engine operating state. Here, the value inside the curly brackets of the second term, that is, the current temperature variation calculated on the basis of the air amount parameter B, is smoothed by the smoothing rate L2 and is then added to the last catalyst temperature variation A(n−1) to thereby obtain the current catalyst temperature variation A(n). Even when the engine operating state varies, there is a time difference to when the influence of the variation is reflected on the catalyst temperature, so the smoothing operation is performed in correspondence with the time difference.

After that, in step S404, a catalyst temperature variation C(n) caused by heat of reaction in the catalyst in the current routine (n) is calculated. The catalyst temperature variation C(n) is obtained by the following mathematical expression (7).

C(n)=C(n−1)+{L3·D−C(n−1)}/L4 (7)

L3 is a predetermined value that may be determined by adaptation, or the like. L4 is a predetermined smoothing rate that is preset as a value larger than 1. D is a parameter that varies with an estimated catalyst temperature Te (estimated temperature parameter), and is determined on the basis of the last estimated catalyst temperature Te(n−1) acquired in step S402 in accordance with a predetermined map. A larger estimated temperature parameter D is obtained as the estimated catalyst temperature Te increases. Here, as in the case of step S403, the value inside the curly brackets of the second term, that is, the current temperature variation calculated on the basis of the estimated temperature parameter D, is smoothed by the smoothing rate L4 and is then added to the last catalyst temperature variation C(n−1) to thereby obtain the current catalyst temperature variation C(n).

Subsequently, in step S405, a catalyst temperature variation E(n) caused by radiation heat from the catalyst in the current routine (n) is calculated. The catalyst temperature variation E(n) is obtained by the following mathematical expression (8).

E(n)=L5·{Te(n−1)−Ta}·F (8)

L5 is a predetermined value that may be determined by adaptation, or the like. Ta is an ambient temperature and is detected by an ambient temperature sensor (not shown). F is a parameter that varies with the speed Vh of a vehicle (that is, vehicle speed) equipped with the engine (vehicle speed parameter), and is determined on the basis of the vehicle speed Vh detected by a vehicle speed sensor (not shown) in accordance with a predetermined map. A larger vehicle speed parameter F is obtained as the vehicle speed Vh increases. A larger catalyst temperature variation E(n) is obtained as the ambient temperature Ta decreases or as the vehicle speed Vh increases.

After that, in step S406, an estimated catalyst temperature Te(n) in the current routine (n) is calculated. The estimated catalyst temperature Te(n) is obtained by the following mathematical expression (9). Thus, the current routine ends.

Te(n)=Te(n−1)+{A(n)+C(n)−E(n)} (9)

As is apparent from the above estimating method, the estimated catalyst temperature Te is irrelevant to the degree of air-fuel ratio variation among the cylinders. Even when there occurs an abnormal air-fuel ratio variation among the cylinders, the estimated catalyst temperature Te takes the same value as that when there occurs no abnormal air-fuel ratio variation among the cylinders. Thus, it is possible to determine whether there is an abnormal air-fuel ratio variation among the cylinders by detecting the degree of deviation of the catalyst temperature detected by the temperature sensor 21 (detected catalyst temperature Ts) from the estimated catalyst temperature Te.

Next, the routine for detecting an abnormal air-fuel ratio variation after completion of warm-up of the engine will be described with reference to FIG. 20. The routine is repeatedly executed by the ECU 20 at predetermined processing intervals.

First, in step S501, it is determined whether a predetermined precondition suitable for detecting an abnormality is satisfied. The precondition is, for example, satisfied when warm-up of the engine has been completed, when the pre-catalyst sensor 17 and the post-catalyst sensor 18 are activated and when the upstream catalyst 11 and the downstream catalyst 19 are activated. The condition of completion of warm-up of the engine is, for example, that the detected coolant temperature is higher than or equal to a predetermined value (for example, 75° C.). The period after time t2 in FIG. 14 corresponds to this condition. The condition of activated pre-catalyst and post-catalyst sensors is that the impedances of both sensors, detected by the ECU 20, are respectively values corresponding to predetermined activation temperatures. The condition of activated upstream and downstream catalysts is that the estimated catalyst temperatures of both catalysts respectively become predetermined activation temperatures. Note that the estimated catalyst temperature of the downstream catalyst 19 is calculated by another routine (not shown).

When the precondition is not satisfied, the routine ends. On the other hand, when the precondition is satisfied, the temperature of the upstream catalyst 11, detected by the temperature sensor 21, that is, the detected catalyst temperature Ts, is acquired in step S502.

Subsequently, in step S503, the temperature of the upstream catalyst 11, estimated by the catalyst temperature estimating routine of FIG. 19, that is, the estimated catalyst temperature Te, is acquired.

In the next step S504, the detected catalyst temperature Ts acquired in step S502 and the estimated catalyst temperature Te acquired in step S503 each are accumulated. That is, after the precondition is satisfied, the detected catalyst temperature Ts and the estimated catalyst temperature Te are separately accumulated routine by routine. In the current routine, the currently acquired detected catalyst temperature Ts and the currently acquired estimated catalyst temperature Te are added to the accumulated detected catalyst temperature Ts and the accumulated estimated catalyst temperature Te that are accumulated until the last routine, and then a current accumulated amount ΣTs of the detected catalyst temperature Ts and a current accumulated amount ΣTe of the estimated catalyst temperature Te are calculated.

After that, in step S505, as in the case of step S103 (FIG. 9), the intake air amount Ga that is the value detected by the air flow meter 5 is accumulated.

In the next step S506, it is determined whether the accumulated intake air amount ΣGa has reached a predetermined value Xs or above. When the determination is negative, the routine ends; whereas, when the determination is affirmative, the routine proceeds to step S507.

In step S507, accumulation of the detected catalyst temperature Ts, the estimated catalyst temperature Te and the intake air amount Ga is terminated. Then, a difference (absolute value) TD between a final accumulated value ΣTs of the detected catalyst temperature and a final accumulated value ΣTe of the estimated catalyst temperature, that is, |ΣTs−ΣTe|, is calculated. Furthermore, the difference TD is corrected on the basis of the oxygen storage capacity OSC, which serves as the catalyst degradation parameter, and the alcohol concentration of fuel, as in the case of step S305 (FIG. 17). Correction based on the oxygen storage capacity OSC is as described above, and the correction coefficient K4 corresponding to the oxygen storage capacity OSC is calculated from a predetermined map similar to the map shown in FIG. 10. Here, because of a difference in condition, that is, before and after completion of warm-up of the engine, values having similar tendency but are different from those of the map shown in FIG. 10 are input in the map for calculating the correction coefficient K4.

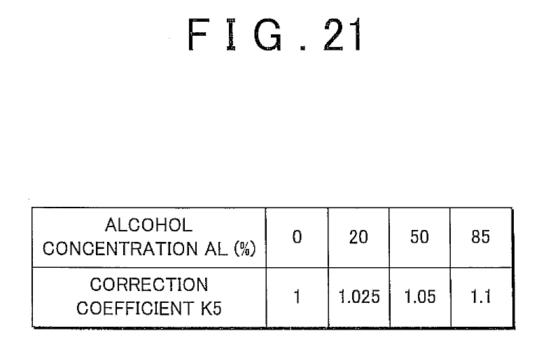

As for correction based on the alcohol concentration of fuel, a correction coefficient K5 corresponding to the alcohol concentration AL (for example, ethanol concentration) detected by the alcohol concentration sensor 34 is obtained from a map prestored in the ECU 20 as shown in FIG. 21. As is apparent from FIG. 21, as the alcohol concentration increases, the correction coefficient K5 increases, and the difference TD is corrected to a further larger value. This is because, as shown in FIG. 14, the exhaust temperature and the catalyst temperature tend to decrease as the alcohol concentration increases after completion of warm-up of the engine (after t2), contrary to the period immediately after a cold start of the engine (t0 to t1). In the map shown in FIG. 21, K5=1.0 when the alcohol concentration AL is 0(%) (that is, during usage of gasoline fuel), and K5 increases from 1.0 as the alcohol concentration AL increases from 0(%).

When the correction coefficients K4 and K5 are obtained in this way, a corrected difference TD' is calculated by the following mathematical expression (10).

TD′=K4×K5×TD (10)

After that, in step S508, the corrected difference TD' is compared with a predetermined abnormality determination value TDs. The abnormality determination value TDs is preset as a value equivalent to a difference between the accumulated value ΣTs of the detected catalyst temperature and the accumulated value ΣTe of the estimated catalyst temperature when the air-fuel ratio variation among the cylinders unacceptably increases (or when the imbalance percentage unacceptably significantly deviates from 0%) because of a failure of a fuel system (for example, the injectors 12), or the like, for part of the cylinders.

When the corrected difference TD′ is smaller than the abnormality determination value TDs, it is determined in step S511 that there is no abnormal air-fuel ratio variation among the cylinders, that is, the air-fuel ratio variation is normal, after which the routine ends.

On the other hand, when the corrected difference TD′ is larger than or equal to the abnormal determination value TDs, it is determined in step S509 that there is an abnormal air-fuel ratio variation among the cylinders. Note that, in synchronization with abnormality determination, an alarm device, such as a check lamp, is desirably activated in order to notify a user of the fact of abnormality. Subsequently, in step S510, as in the case of step S108 (FIG. 9), the following active air-fuel ratio control is prohibited, after which the routine ends.

In correction of the alcohol concentration, the abnormality determination value TDs may be corrected instead of the difference TD. In this case, as the alcohol concentration AL of fuel increases, the abnormality determination value TDs is corrected to reduce. In addition, detecting an abnormal variation after completion of warm-up of the engine may be not only carried out when detection during a cold start of the engine immediate after fuel filling is prohibited or stopped but also solely carried out after completion of warm-up of the engine.

Note that, if a new fuel having an alcohol concentration different from that of a previous fuel present in the fuel tank 32 is filled into the fuel tank 32, as described above, the alcohol concentration of fuel, detected by the alcohol concentration sensor 34, differs from the alcohol concentration of fuel injected from the injectors 12, and the alcohol concentration cannot be accurately corrected for a while immediately after fuel filling. Then, during then, detecting an abnormal variation after completion of warm-up of the engine may be prohibited or stopped. By so doing, it is possible to prevent an erroneous determination or an erroneous detection.

In addition, it is also possible to estimate the catalyst temperature using a parameter other than the intake air amount, the ambient temperature or the vehicle speed.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

What is claimed is:

1. An apparatus for detecting an abnormal air-fuel ratio variation among cylinders of a multi-cylinder internal combustion engine, comprising:
a catalyst that is arranged in an exhaust passage of the multi-cylinder internal combustion engine;
a catalyst temperature detecting unit that detects a temperature of the catalyst; and
an abnormality detecting unit that detects an abnormal air-fuel ratio variation among the cylinders on the basis of the detected catalyst temperature, wherein
the abnormality detecting unit calculates a temperature parameter on the basis of the detected catalyst temperature, and
the abnormality detecting unit detects the abnormal air-fuel ratio variation among the cylinders on the basis of the temperature parameter at the time when a predetermined period of time has elapsed after a cold start of the internal combustion engine.

2. The apparatus according to claim 1, further comprising a catalyst degradation parameter measuring unit that measures a catalyst degradation parameter related to a degree of degradation of the catalyst, wherein
the abnormality detecting unit compares the temperature parameter at the time when the predetermined period of time has elapsed with a predetermined abnormality determination value to thereby detect the abnormal air-fuel ratio variation among the cylinders, and
the abnormality detecting unit corrects the temperature parameter at the time when the predetermined period of time has elapsed or the abnormality determination value in accordance with the measured catalyst degradation parameter.

3. The apparatus according to claim 2, wherein, when the abnormality detecting unit carries out correction in accordance with the measured catalyst degradation parameter, the abnormality detecting unit corrects the temperature parameter toward a high temperature side or corrects the abnormality determination value toward a low temperature side.

4. The apparatus according to claim 1, further comprising an average air-fuel ratio measuring unit that measures an average air-fuel ratio of exhaust gas supplied to the catalyst by the time when the predetermined period of time elapses after a cold start of the internal combustion engine, wherein
the abnormality detecting unit compares the temperature parameter at the time when the predetermined period of time has elapsed with a predetermined abnormality determination value to thereby detect the abnormal air-fuel ratio variation among the cylinders, and
the abnormality detecting unit corrects the temperature parameter at the time when the predetermined period of time has elapsed or the abnormality determination value in accordance with the measured average air-fuel ratio.

5. The apparatus according to claim 4, wherein, when the abnormality detecting unit carries out correction in accordance with the average air-fuel ratio measured when the average air-fuel ratio is leaner than a stoichiometric air-fuel ratio, the abnormality detecting unit corrects the temperature parameter toward a low temperature side or corrects the abnormality determination value toward a high temperature side.

6. The apparatus according to claim 2, further comprising an average air-fuel ratio measuring unit that measures an average air-fuel ratio of exhaust gas supplied to the catalyst by the time when the predetermined period of time elapses after a cold start of the internal combustion engine, wherein
the abnormality detecting unit compares the temperature parameter at the time when the predetermined period of time has elapsed with a predetermined abnormality determination value to thereby detect the abnormal air-fuel ratio variation among the cylinders, and
the abnormality detecting unit corrects the temperature parameter at the time when the predetermined period of time has elapsed or the abnormality determination value in accordance with the measured average air-fuel ratio.

7. The apparatus according to claim 6, wherein, when the abnormality detecting unit carries out correction in accordance with the average air-fuel ratio measured when the average air-fuel ratio is leaner than a stoichiometric air-fuel ratio, the abnormality detecting unit corrects the temperature parameter toward a low temperature side or corrects the abnormality determination value toward a high temperature side.

8. The apparatus according to claim 1, further comprising a prohibiting unit that, when the abnormal air-fuel ratio variation among the cylinders is detected by the abnormality detecting unit, prohibits active air-fuel ratio control thereafter.

9. The apparatus according to claim 1, further comprising an abnormal cylinder identifying unit that, when the abnormal air-fuel ratio variation among the cylinders is detected by the abnormality detecting unit, forcibly increases or decreases a fuel injection amount for each of the cylinders and, during then, identifies an abnormal cylinder on the basis of a change in the detected catalyst temperature.

10. The apparatus according to claim 9, wherein
the abnormal cylinder identifying unit identifies the cylinder, due to which the catalyst temperature decreases by a predetermined value or above when the fuel injection amount is forcibly reduced, as the abnormal cylinder, and
the abnormal cylinder identifying unit identifies the cylinder, due to which the catalyst temperature decreases by a predetermined value or above when the fuel injection amount is forcibly increased, as the abnormal cylinder.

11. The apparatus according to claim 1, further comprising an alcohol concentration acquisition unit that detects or estimates an alcohol concentration of fuel, wherein
the abnormality detecting unit compares the temperature parameter at the time when the predetermined period of time has elapsed with a predetermined abnormality determination value to thereby detect the abnormal air-fuel ratio variation among the cylinders, and corrects the temperature parameter at the time when the predetermined period of time has elapsed or the abnormality determination value in accordance with the detected or estimated alcohol concentration.

12. The apparatus according to claim 1, further comprising an alarm unit that alarms that there is an abnormality when the abnormality is detected by the abnormality detecting unit.

13. The apparatus according to claim 1, wherein
the catalyst temperature detecting unit is a temperature sensor, and
a temperature detecting portion of the temperature sensor is located upstream of a middle position of the catalyst in a flow passage direction.

14. An apparatus for detecting an abnormal air-fuel ratio variation among cylinders of a multi-cylinder internal combustion engine, comprising:
a catalyst that is arranged in an exhaust passage of the multi-cylinder internal combustion engine;
a catalyst temperature detecting unit that detects a temperature of the catalyst; and
an abnormality detecting unit that detects an abnormal air-fuel ratio variation among the cylinders on the basis of the detected catalyst temperature, wherein
the abnormality detecting unit detects the abnormal air-fuel ratio variation among the cylinders on the basis of the detected catalyst temperature at the time when a predetermined period of time has elapsed after a cold start of the internal combustion engine.

15. The apparatus according to claim 14, wherein the abnormality detecting unit detects the abnormal air-fuel ratio variation among the cylinders on the basis of a difference between an initial catalyst temperature and the detected catalyst temperature at the time when the predetermined period of time has elapsed after a cold start of the internal combustion engine.

16. The apparatus according to claim 14, wherein the abnormality detecting unit detects the abnormal air-fuel ratio variation among the cylinders on the basis of an accumulated value of a difference between an initial catalyst temperature and the detected catalyst temperature during a period until the time when the predetermined period of time has elapsed after a cold start of the internal combustion engine.
